(19) United States
(12) Patent Application Publication
(10) Pub. No.: US 2023/0206338 A1
(43) Pub. Date: Jun. 29, 2023

(54) Systems and Methods in a Decentralized Network

(71) Applicant: Steamroller Systems, Inc., DALLAS, TX (US)

(72) Inventor: Cole St. Clair Davis, Dallas, TX (US)

(21) Appl. No.: 18/146,827

(22) Filed: Dec. 27, 2022

Related U.S. Application Data
(60) Provisional application No. 63/294,275, filed on Dec. 28, 2021.

(51) Int. Cl. G06Q 40/06

(52) U.S. Cl. CPC G06Q 40/06; G06Q 50/188

(57) ABSTRACT

In one embodiment, a method includes receiving a request for a transaction from a first party and identifying a second party for the transaction. The first party is associated with a first party decentralized identifier (DID), and the second party is associated with a second party DID. The method also includes receiving negotiation data from the first party and the second party and generating a data model using the first party DID, the second party DID, and the negotiation data. The method further includes generating a hybrid legal document using the data model and a legal prose document.

### BACKGROUND

A computing network may include computers that communicate with each other via a network. As an example, a network may include wired, optical, and/or wireless interconnections arranged in a variety of network topologies. Examples of computers may include user devices (such as personal computers, laptops, smartphones, clients, etc.), servers, hosts, gateways, switches, routers, or other specialized or general-purpose computers. A computer may be identified by an address, such as an Internet Protocol (IP) address, that facilitates locating the computer on the network. The computing network may support applications and services provided by the computers.

### BRIEF DESCRIPTION OF THE DRAWINGS

FIG. 1 illustrates a system for generating decentralized applications in a decentralized network, in accordance with certain embodiments.

FIGS. 2 through 6 illustrate a plurality of algorithmic identity systems, in accordance with certain embodiments.

FIGS. 7 and 8 illustrate an autonomic identity system and its associated key event log, in accordance with certain embodiments

FIG. 9 illustrates a hybrid legal contract, in accordance with certain embodiments.

FIGS. 10 and 11 illustrate flow diagrams for generating hybrid legal contract files using a unilateral framework, in accordance with certain embodiments.

FIG. 12 illustrates a flow diagram for generating hybrid legal contract files using a multi-party framework, in accordance with certain embodiments.

FIG. 13 illustrates a flow diagram for a contracting party to search for assets with which to transact, in accordance with certain embodiments.

FIG. 14 illustrates a flow diagram for resolving asset owner decentralized identifiers (DIDs) from an asset DID and its decentralized public key infrastructure (DPKI) metadata, in accordance with certain embodiments.

FIG. 15 illustrates a flow diagram for a contracting party to search for service providers or employees with which to transact, in accordance with certain embodiments.

FIG. 16 illustrates a flow diagram for a contracting party to submit a transaction request to a service provider, in accordance with certain embodiments.

FIG. 17 illustrates a flow diagram for a contracting party to populate a data model for a transaction request, in accordance with certain embodiments.

FIG. 18 illustrates a flow diagram for a contracting party to submit a transaction request to an asset owner, in accordance with certain embodiments.

FIG. 19 illustrates a flow diagram for using legal logic to automate ongoing legal obligations, in accordance with certain embodiments.

FIG. 20 illustrates a flow diagram for digitally signing a hybrid legal contract, in accordance with certain embodiments.

FIG. 21 illustrates a flow diagram for generating a hybrid journal entry, in accordance with certain embodiments.

FIG. 22 illustrates a flow diagram for generating hybrid journal entries for contracting parties, respectively, in accordance with certain embodiments.

FIG. 23 illustrates a flow diagram for populating a hybrid journal entry and posting the hybrid journal entry to a hybrid general ledger, in accordance with certain embodiments.

FIG. 24 illustrates a diagram for establishing ownership of an asset using DIDs, in accordance with certain embodiments.

FIG. 25 illustrates a flow diagram for populating the controller property of an asset DID in the asset DPKI metadata using a hybrid legal contract, in accordance with certain embodiments.

FIG. 26 illustrates a flow diagram for documenting a transfer of ownership interest in an asset, in accordance with certain embodiments.

FIG. 27 illustrates a flow diagram for encapsulating legal contract provisions of a hybrid legal contract file within verifiable credentials, in accordance with certain embodiments.

FIG. 28 illustrates a flow diagram for issuing a verifiable credential based on legal provisions in a hybrid legal contract, in accordance with certain embodiments.

FIG. 29 illustrates a flow diagram for aggregating data sets to train machine learning models, in accordance with certain embodiments.

FIG. 30 illustrates a flow diagram for applying machine learning techniques to aggregated data sets, in accordance with certain embodiments.

FIG. 31 illustrates a flow diagram for aggregating data sets to train machine learning models, in accordance with certain embodiments.

FIG. 32 illustrates a flow diagram for performing federated learning on datasets through a decentralized identity system, in accordance with certain embodiments.

FIG. 33 illustrates a flow diagram for training machine learning models on centrally aggregated datasets through a decentralized identity system, in accordance with certain embodiments.

FIG. 34 illustrates a computer system that may be used by the systems and methods described herein, in accordance with certain embodiments.

### DESCRIPTION OF EXAMPLE EMBODIMENTS

### Overview

According to a first embodiment of a first set of embodiments, a system includes one or more processors and one or more computer-readable non-transitory storage media coupled to the one or more processors and including instructions that, when executed by the one or more processors, cause the first one or more processors to perform operations. The operations include receiving a legal document associated with a party and classifying the legal document into one or more classifications. The operations also include obtaining a party DID associated with the party. The operations also include generating a data model using the party DID and the one or more classifications. The operations further include generating a hybrid legal document using the data model.

In certain embodiments, the one or more classifications are associated with at least one of the following types of classifications: a document type, a clause type, an identity of the party, and a subject of the legal document.

In some embodiments, obtaining the party DID includes one of the following: resolving an identity of the party to obtain the party DID from a registry, or providing functionality for the party to generate the party DID.

In certain embodiments, the hybrid legal document includes a human-readable legal prose and the data model. A markup language may be used to tag parameters in the human-readable legal prose. The parameters may be populated in the data model. In certain embodiments, the parameters are associated with the following: a variable name, a data type, and a value.

In some embodiments, the operations include resolving an identity of a subject of the hybrid legal document to obtain a subject DID from a registry or providing functionality for the party to generate the subject DID.

In certain embodiments, the operations include generating a hybrid journal entry. The hybrid journal entry may be populated using one or more parameter values from the data model.

In some embodiments the hybrid legal document is associated with one of the following: an asset purchase agreement, a copyright license, a lease of real estate property, a lease of mineral rights, an employment agreement, a corporate governance document, a copyright split sheet, a will, or a service provider document.

According to a second embodiment of the first set of embodiments, a method includes receiving a legal document associated with a party and classifying the legal document into one or more classifications. The method also includes obtaining a party DID associated with the party. The method also includes generating a data model using the party DID and the one or more classifications. The method further includes generating a hybrid legal document using the data model.

According to a third embodiment of the first set of embodiments, one or more computer-readable non-transitory storage media embody instructions that, when executed by a processor, cause the processor to perform operations. The operations include receiving a legal document associated with a party and classifying the legal document into one or more classifications. The operations also include obtaining a party DID associated with the party. The operations also include generating a data model using the party DID and the one or more. The operations further include generating a hybrid legal document using the data model.

According to a first embodiment of a second set of embodiments, a system includes one or more processors and one or more computer-readable non-transitory storage media coupled to the one or more processors and including instructions that, when executed by the one or more processors, cause the first one or more processors to perform operations. The operations include receiving a request for a transaction from a first party and identifying a second party for the transaction. The first party is associated with a first party decentralized identifier (DID), and the second party is associated with a second party DID. The operations also include receiving negotiation data from the first party and the second party and generating a data model using the first party DID, the second party DID, and the negotiation data. The operations further include generating a hybrid legal document using the data model and a legal prose document.

In certain embodiments, the request for the transaction is associated with one of the following: a direct search for a subject of the transaction, wherein the subject of the transaction is an asset, a person, or a service or service provider; a search for the subject of the transaction based on one or more search parameters; or a query requesting submissions of potential subjects of the transaction based on one or more search parameters.

In some embodiments, the operations include generating a journal entry using data model parameters of the hybrid legal document, populating the journal entry with fee values derived from the data model parameters, and/or populating the journal entry with financial settlement information.

In certain embodiments, the operations include determining that the hybrid legal document transfers ownership of an asset from the second party to the first party, wherein the asset is associated with an asset DID, populating the first party as a new controller of the asset DID, and/or removing the second party as a controller of the asset DID.

In some embodiments, the operations include identifying a subject DID for a subject of the transaction, wherein the subject of the transaction is associated with an asset, a person, an entity, or a service provider and/or generating the data model using the subject DID.

In certain embodiments, the operations include identifying a subject of the transaction and determining, based on the data model, capabilities associated with the subject of the transaction. The capabilities may include ownership, administration, or authorization capabilities. In some embodiments, the operations include generating a credential graph. The credential graph may include a claim defining the capabilities associated with the subject of the transaction.

In some embodiments, the hybrid legal document is associated with one of the following: an asset purchase agreement; a copyright license; a lease of real estate property; a lease of mineral rights; an employment agreement; a corporate governance document; a copyright split sheet; a will; or a service provider document.

According to a second embodiment of the second set of embodiments, a method includes receiving a request for a transaction from a first party and identifying a second party for the transaction. The first party is associated with a first party decentralized identifier (DID), and the second party is associated with a second party DID. The method also includes receiving negotiation data from the first party and the second party and generating a data model using the first party DID, the second party DID, and the negotiation data. The method further includes generating a hybrid legal document using the data model and a legal prose document.

According to a third embodiment of the second set of embodiments, one or more computer-readable non-transitory storage media embody instructions that, when executed by a processor, cause the processor to perform operations. The operations include receiving a request for a transaction from a first party and identifying a second party for the transaction. The first party is associated with a first party decentralized identifier (DID), and the second party is associated with a second party DID. The operations also include receiving negotiation data from the first party and the second party and generating a data model using the first party DID, the second party DID, and the negotiation data. The operations further include generating a hybrid legal document using the data model and a legal prose document.

According to a first embodiment of a third set of embodiments, a system includes one or more processors and one or more computer-readable non-transitory storage media coupled to the one or more processors and including instructions that, when executed by the one or more processors, cause the first one or more processors to perform operations. The operations include identifying datasets associated with a party and identifying one or more decentralized identifiers (DIDs) associated with the datasets. The operations also include generating an aggregated dataset associated with the DIDs and generating a training dataset associated with the aggregated dataset. The operations further include using one or more machine learning algorithms to recognize patterns within the training dataset.

In certain embodiments, the aggregated dataset includes one or more types of data from the following types of data: legal data associated with one or more hybrid legal documents; workflow data associated with one or more negotiations of one or more hybrid legal documents; accounting data associated with one or more hybrid journal entries; and/or subject data associated with one or more subjects of one or more hybrid legal documents, wherein each of the one or more subjects is associated with an asset, a person, an entity, or a service provider.

In some embodiments, the aggregated datasets are stored in one or more data stores controlled by the party. In certain embodiments, the machine learning algorithms include one or more types of algorithms. The types of algorithms may include supervised learning algorithms, unsupervised learning algorithms, self-supervised learning algorithms, and/or reinforcement learning algorithms.

In certain embodiments, identifying the datasets associated with the party includes receiving the datasets from the party, receiving permission from the party to access the datasets from a data store controlled by the party, or receiving permission from the party to access and obtain the datasets from the data store controlled by the party.

In some embodiments, the training dataset includes one or more descriptive attributes from the following set of descriptive attributes: a contract type value, a date value, a contract provision a payment term, a party characteristic; and/or a characteristic of the subject of a hybrid legal document.

In certain embodiments, the aggregated datasets are associated with one or more types of documents, the types of documents including: an asset purchase agreement; a copyright license; a lease of real estate property; a lease of mineral rights; an employment agreement; a corporate governance document; a copyright split sheet; a will; or a service provider document.

According to a second embodiment of the third set of embodiments, a method includes identifying datasets associated with a party and identifying one or more decentralized identifiers (DIDs) associated with the datasets. The method also includes generating an aggregated dataset associated with the DIDs and generating a training dataset associated with the aggregated dataset. The method further includes using one or more machine learning algorithms to recognize patterns within the training dataset.

According to a third embodiment of the third set of embodiments, one or more computer-readable non-transitory storage media embody instructions that, when executed by a processor, cause the processor to perform operations. The operations include identifying datasets associated with a party and identifying one or more decentralized identifiers (DIDs) associated with the datasets. The operations also include generating an aggregated dataset associated with the DIDs and generating a training dataset associated with the aggregated dataset. The operations further include using one or more machine learning algorithms to recognize patterns within the training dataset.

Technical advantages of certain embodiments of this disclosure may include one or more of the following. The systems and methods described herein use a suite of emerging technologies to reduce transaction costs that are often associated with legal contracting. The framework described in certain embodiments of this disclosure is based on a combination of software-based legal contracts and DIDs derived from asymmetric key cryptography for one or more users, assets, and contracts, which reduces transaction costs that are often associated with legal contracting.

In certain embodiments, software-based legal contracts (e.g., hybrid legal contracts and hybrid legal documents) have structured data that represent the legal relationships embodied in the contract. This makes the hybrid legal contract both human-readable and machine-readable. The data model of these hybrid legal contracts can integrate the DIDs of the counterparties to the contracts as well as any subjects of the contracts (e.g., assets, service providers, employees, etc.). Because the DIDs can be resolved to obtain information about the subject of the DID (e.g., where to send messages, how to send payments, etc.), the hybrid legal contract becomes a comprehensive identity repository for the legal relationship. The information associated with the DIDs (e.g., DPKI metadata, verifiable credentials, etc.) can streamline the transacting process. In certain embodiments, the DIDs and hybrid legal contracts allow peer-to-peer transacting and client-side data aggregation of legal, financial, and/or accounting information.

In certain embodiments, the structured legal data in the hybrid legal contract's data model is mapped to the schema of a verifiable credential, which allows certain aspects of the contract to be represented in a cryptographically verifiable, digital form. This credential may be presented by the holder to a verifier to confirm certain facts about a legal relationship, such as counterparty authorizations and capabilities, the status of the contract itself, or the “state” of ownership and control of both a “real world” asset and a digital representation of that asset (in the form of an asset DID). In certain embodiments, legal documents other than contracts are mapped to a verifiable credential, such as a written consent of a board of directors relating to the authority of a corporate officer.

In some embodiments, the structured data of the hybrid legal contract's data model is used as inputs to logical functions that can implement legal logic contained within the legal prose of the contract (e.g., automated payments upon the occurrence of a certain event; a change of control of both the asset and the asset identity upon the occurrence of a certain event; etc.).

In certain embodiments, the asset identity and its “data container” (in the form of DPKI metadata and resources that can be dereferenced from the DPKI metadata) aggregates information about the asset as it flows through a supply chain and is the subject of other transactions, which provides the owners of the asset in the “real world” a single repository for data and metadata about an asset (e.g., transaction data, asset characteristics, chain of title, etc.).

In some embodiments, the DIDs and their DPKI metadata are independent of any underlying transaction platform on which the DIDs are generated and/or used. Because they are created through asymmetric key cryptography, the DID controller can decide how, when, and where the DIDs engage in transactions and where transaction-related data is stored. This makes the identities and the reputations associated with the identities portable across different services and trust boundaries.

In certain embodiments, the data model associated with a hybrid legal contract is used to populate a hybrid journal entry that classifies the transaction for one or both counterparties. The shared data model ensures consistency between the legal and accounting relationship inherent in a single transaction. The structured accounting data from a hybrid journal entry, which also includes the DIDs of any counterparties and subjects of the transaction, may be used to populate other aspects of a traditional accounting system, including a general ledger, a trial balance, adjusting journal entries, and financial statements. This helps streamline the audit function and provides a unified framework for legal, financial, and accounting functions with inherent cryptographic verifiability.

In some embodiments, the decentralized identity framework allows data to be stored under the control of end users. All data associated with commercial transactions (e.g., legal data, financial data, accounting data, asset data, counterparty data, etc.) may be stored in structured format in separate databases associated with the applicable DIDs. This prevents centralized control of such data, helps ensure end user data privacy, and reduces the possibility of data breaches of a centralized data repository.

In certain embodiments, a decentralized application is given permissioned access to data to perform data analytics and/or machine learning on behalf of end users. In some embodiments, a decentralized application is given access to obtain aggregated datasets and training data so the application can train machine learning models or perform data analytics in a central repository. Once training and/or analysis is complete, the data may be deleted from an application server and the decentralized application can then provide enhanced services to end users.

In some embodiments, the decentralized application perform distributed federated machine learning and data analytics on datasets still under the control of end users. In certain embodiments, the decentralized application uses privacy-enhancing techniques such as differential privacy, homomorphic or functional encryption, and secure multiparty computation to ensure the underlying datasets remain private to both the decentralized application and third parties. This allows the decentralized application to provide data analytics and machine learning functions to end users without having access to the underlying datasets, which may include confidential legal, financial, accounting, and asset information.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

This disclosure describes systems and methods for generating decentralized applications in a decentralized network. In many different industries, when one party wishes to engage in a transaction with another party, significant costs result from searching for the counterparty. For example, in the oil and gas industry, an exploration/production company may employ an in-house or independent landman to research and identify the legal owners of a tract of land in order to acquire mineral rights. As another example, in the music industry, a filmmaker may employ a music clearance agent or lawyer to research and identify the owners of one or more music copyrights in order to negotiate a license to use the music in a film.

Once the proper counterparties are identified, the exploration/production company or filmmaker—or their landman or clearance agent—determines how to contact the counterparties to communicate a transaction request. The counterparties may then negotiate a legal contract to govern their relationship. The legal contract creates a financial right or obligation in exchange for the right to acquire or use the asset or receive a given service. The counterparties may monitor their performance to ensure both sides receive the benefit of the bargain and potentially enforce the contract for non-performance. The financial right or obligation that flows from the legal contract may be classified according to a given accounting framework (e.g., generally accepted accounting principles (GAAP) in the United States) to prepare financial statements for purposes of raising debt and/or equity to operate the business. Each of the steps in this transaction workflow may require specialists, including middlemen such as landmen or clearance agents along with lawyers and accountants, as well as separate systems to manage the data and documents that are generated during the transaction lifecycle.

The inefficiencies and costs associated with the process of searching for and communicating with potential counterparties, especially when researching asset owners or administrators to purchase or use an asset, is at least in part due to the fragmentation of identities associated with the owner and the asset itself across multiple static, siloed databases and systems. For example, a music copyright's “identity” can be defined by: (1) numerical identifiers (e.g., International Standard Musical Work Codes (ISWCs), International Standard Recording Codes (ISRCs), universal product codes (UPCs), performing rights organization identifiers, copyright registration numbers, etc.); (2) the copyright owners (e.g., songwriters or recording artists who created the work); (3) the current and previous owners in the chain of title; (4) the song name, sound recording name, and/or album name on which it appears; and (5) qualitative and/or quantitative characteristics (e.g., genre, tempo, chart position, historical earnings, etc.).

Obtaining a holistic view of a copyright's “identity” to determine whether to transact with the copyright's owner or administrator is difficult because this information is spread across many different databases owned by different entities that do not interoperate. The copyright has no persistent digital identity that can aggregate data about itself throughout the supply chain. Tracking ownership changes is difficult because various static ownership databases are divorced from the legal workflows and contracts that determine ownership. This occurs with many other types of assets, too.

Ownership of an asset and whether it is available for a particular transaction request may be determined by legal contracts that were previously executed and exist earlier in a supply chain and/or chain of title. These legal contracts are often static, and the contract management systems that organize them are often siloed such that contracts that may impact the ability of a party to engage in a given transaction cannot interact with other contracts or with external systems. Instead, counterparties identify and review applicable contracts manually. Contracts often lack persistent identifiers, and like assets are generally not able to aggregate data about themselves throughout their lifetimes.

The net result of these centralized data siloes, fragmented identities, and static legal contracts is transaction costs. These transaction costs may be classified generally as search and information costs (e.g., identifying a counterparty and determining if an asset or service is available for transacting); bargaining and decision costs (e.g., negotiating and executing a legal contract to govern the transaction); and policing and enforcement costs (e.g., monitoring performance and enforcing the contract formally or informally if needed). In certain markets, these transaction costs are high enough to deter willing counterparties from engaging in a transaction, even if there is demand for transacting by both parties. In certain situations, transaction costs exceed the value of the transaction itself. These transaction costs and the inefficient markets they produce are pervasive in the synchronization licensing market (e.g., when licensing music into audiovisual works such as films or television shows). Other industries and markets are affected by high transaction costs and inefficient markets as well, where middlemen are required to reduce transaction costs enough for transactions to make economic sense.

The systems and methods described herein use a framework based on DIDs derived from asymmetric key cryptography for one or more users, assets, and/or contracts. The DIDs allow peer-to-peer transacting and client-side data aggregation of legal, financial, and/or accounting information. Certain embodiments described herein convert legal, financial, and/or accounting data into structured data that is stored on the client side. This structured data assists in making legal contracts interactive and is more amenable to machine learning techniques.

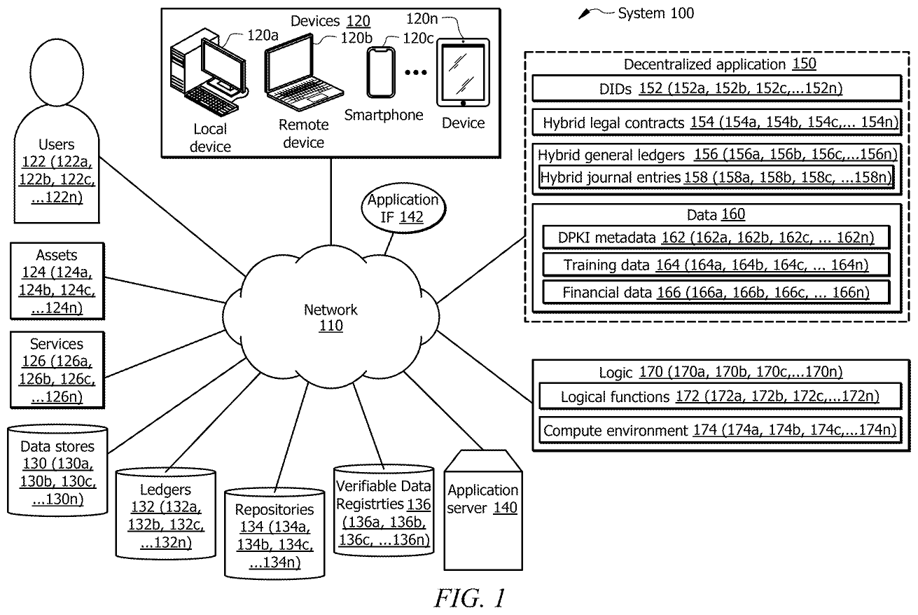

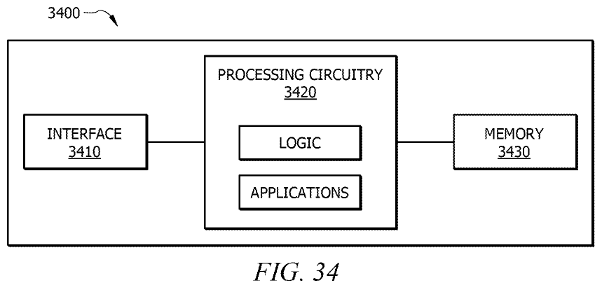

FIG. 1 illustrates a system 100 for generating a decentralized application in a decentralized network, in accordance with certain embodiments. System 100 or portions thereof may be associated with a person or entity, which may include any person or entity, such as an owner, a business, a company, or an enterprise, that uses decentralized applications in a decentralized network. The components of system 100 may include any suitable combination of hardware, firmware, and software. For example, the components of system 100 may use one or more elements of the computer system of FIG. 34.

In the illustrated embodiment of FIG. 1, system 100 includes a network 110, devices 120, users 122, assets 124, services 126, data stores 130, distributed ledgers 132, repositories 134, verifiable data registries 136, an application server 140, an application interface 142, a decentralized application 150, DIDs 152, hybrid legal contracts 154, hybrid general ledgers 156, hybrid journal entries 158, data 160, logic 170, logical functions 172, and compute environments 174.

Network 110 of system 100 is any type of network that facilitates communication between components of system 100. Network 110 may connect one or more components of system 100. One or more portions of network 110 may include an ad-hoc network, an Internet, an intranet, an extranet, a virtual private network (VPN), an Ethernet VPN (EVPN), a local area network (LAN), a wireless LAN (WLAN), a virtual LAN (VLAN), a wide area network (WAN), a wireless WAN (WWAN), a software-defined wide area network (SD-WAN), a metropolitan area network (MAN), a portion of the Public Switched Telephone Network (PSTN), a cellular telephone network, a Digital Subscriber Line (DSL), a multi-protocol label switching (MPLS) network, a WI-FI network, a 3G/4G/5G network, a long-term evolution (LTE) network, a cloud network, a private network, a public network, a mobile network, a combination of two or more of these, or other suitable types of networks. In certain embodiments, network 110 may include one or more different types of networks.

Network 110 of system 100 may include one or more nodes. Nodes are connection points within network 110 that receive, create, store and/or send data along a path. Nodes may include one or more redistribution points that recognize, process, and forward data to other nodes of network 110. Nodes may include virtual and/or physical nodes. For example, nodes may include one or more virtual machines, bare metal servers, and the like. As another example, nodes may include data communications equipment such as computers, routers, servers, printers, workstations, switches, bridges, modems, hubs, and the like. In the illustrated embodiment of FIG. 1, nodes of network 110 include devices 120, data stores 130, application server 140, etc.

Devices 120 of system 100 include any user equipment that can receive, create, process, store, and/or communicate information. Devices 120 may include one or more workstations, desktop computers, laptop computers, mobile phones (e.g., smartphones), tablets, personal digital assistants (PDAs), wearable devices, and the like. Devices 120 may include a liquid crystal display (LCD), an organic light-emitting diode (OLED) flat screen interface, digital buttons, a digital keyboard, physical buttons, a physical keyboard, one or more touch screen components, a graphical user interface (GUI), and/or the like. Devices 120 may be located in any suitable location to receive and communicate information to user 122 of system 100. In the illustrated embodiment of FIG. 1, devices 120 of system 100 include local workstation 120a, remote laptop 120b, smartphone 120c, and so on to tablet 120n, where n represents any suitable integer.

Users 122 of system 100 are persons who utilize one or more devices 122 of system 100. Users 122 may be associated with one or more legal transactions, legal documents, assets 124, services 126, data stores 130, accounts, DIDs 152, and the like. Users 122 may include local users, remote users, administrators, asset owners, service providers, parties, counterparties, customers, companies, a combination thereof, and the like. Users 122 may be associated with a username, a password, a user profile, etc. In the illustrated embodiment of FIG. 1, users 122 of system 100 include user 122a, user 122b, user 122c, and so on to user 122n, where n represents any suitable integer.

Assets 124 of system 100 are resources owned and/or controlled by users 122 (e.g., a person, a business, an economic entity, etc.). In certain embodiments, assets 124 may be used to generate positive economic value. Assets 124 may be tangible (e.g., cash, inventory, accounts receivable, land, buildings, equipment, etc.) or intangible (goodwill, copyrights, trademarks, patents, computer programs, financial investments, bonds, stocks, etc.). In certain embodiments, assets 124 represent the subjects of hybrid legal contracts 154. For example, assets 124 may represent intellectual property rights (e.g., copyrights), real estate, mineral rights, etc. In the illustrated embodiment of FIG. 1, assets 124 of system 100 include asset 124a, asset 124b, asset 124c, and so on to asset 124n, where n represents any suitable integer.

Services 126 of system 100 include intangible acts for which consumers (e.g., persons, companies, governments, etc.) are willing to pay. Services 126 may represent work performed by the entertainment industry (e.g., the music industry, the film industry, etc.), the oil and gas industry, real estate agents, lawyers, banks, insurance companies, accountants, and so on. In the illustrated embodiment of FIG. 1, services 126 of system 100 include service 126a, service 126b, service 126c, and so on to service 126n, where n represents any suitable integer.

Data stores 130 of system 100 are digital data storage locations that store, manage, and/or distribute collections of data 160. Data stores 130 may include one or more databases, file systems, email storage systems, spreadsheets, distributed data stores, distributed ledgers 132, repositories 134, verifiable data registries 136, a combination thereof, and so on. Data stores 130 may include database management systems (DBMS), MATLAB cloud storage systems (e.g., VMware, Firefox OS, etc.), and the like. In the illustrated embodiment of FIG. 1, data stores 130 of system 100 include data store 130a, data store 130b, data store 130c, and so on to data store 130n, where n represents any suitable integer.

Data stores 130 may include personal data stores, identity hubs, encrypted data vaults, data pods, and the like. In certain embodiments, users 122 of system 100 may use data stores 130 to aggregate data 160. For example, users 122 may aggregate data 160 about their DIDs 152, transactions their DIDs engage in, and the like in their respective data stores 130. In certain embodiments, data stores 130 may be owned and/or controlled by one or more users 122. For example, user 122a of system 100 may own/control data store 130a, user 122b of system 100 may own/control data store 130b, and so on.

Distributed ledgers 132 of system 100 represent databases that are synchronized and accessible across different sites and geographies by multiple users 122. In certain embodiments, distributed ledgers 132 maintain transactions and/or in decentralized form across different locations and users 122. Distributed ledgers 132 may include distributed file systems, verifiable data registries 136, and the like. Distributed ledgers 132 may be classified as private, public, permissioned, permissionless, or a combination thereof. Types of distributed ledgers 132 include blockchain, hashgraph, Directed Acyclic Graph (DAG), Holochain, Tempo (Radix), etc. In the illustrated embodiment of FIG. 1, distributed ledgers 132 of system 100 include distributed ledger 132a, distributed ledger 132b, distributed ledger 132c, and so on to distributed ledger 132n, where n represents any suitable integer.

Repositories 134 of system 100 represent locations (e.g., databases) where data associated with hybrid legal contracts 154 are stored. Repositories 134 may include application-based hybrid contract repositories, third-party contract repositories, third-party/open-source logic repositories, application logic repositories, and the like. In the illustrated embodiment of FIG. 1, repositories 134 of system 100 include repository 134a, repository 134b, repository 134c, and so on to repository 134n, where n represents any suitable integer.

Verifiable data registries 136 of system 100 represent tools that facilitate the creation, verification, updating, and/or deactivation of DIDs 152 and/or DPKI metadata 162. Verifiable data registries 136 may mediate the creation and/or verification of identifiers, cryptographic keys, verifiable credential schemas, revocation registries, issuer public keys, etc. Verifiable data registries may include distributed ledgers 136, distributed file systems, verifiable name registries, witness networks for key event logs, and the like.

Application server 140 of system 100 is a server that hosts decentralized application 150 and/or software that communicates decentralized application 150 to other components of system 100 via one or more communication protocols. In certain embodiments, application server 140 provides access to logic 170 for use by decentralized application 150. In certain embodiments, application server 140 includes software components available to one or more users 122 of system 100 via an application interface 142.

Application interface 142 of system 100 is an application programming interface (API) that represents a set of rules that dictate how two components of system 100 communicate with each other. For example, application interface 142 provide for interactions such as application server 140 communicating with decentralized application 150, application server 140 pinging other application servers, decentralized application communicating with an operating system, and so on. In certain embodiments, application interface 142 allows users 122 to provide input to and/or receive output from decentralized application 150. Decentralized application 150 of system 100 represents an application that provides legal, financial, and/or accounting functionality to users 122 that have DIDs 152. Decentralized application 150 may operate through the use of hybrid legal contracts 154 and/or hybrid journal entries 158 that are implemented on computing infrastructure selected by users 122. In certain embodiments, decentralized application 150 performs specific functions (e.g., logical functions 172). Decentralized application 150 may include web browsers, multimedia software, content access software, enterprise software, database software, and the like. In some embodiments, decentralized application 150 receives permission to read/write data 160 to/from data store 130 of user 122. In some embodiments, users 122 read/write data 160 to/from their own data stores 130.

DIDs 152 of system 100 represent globally unique, persistent identifiers that do not require a centralized registration authority. In certain embodiments, DIDs 152 are URL-based identifiers. DIDs 152 may be generated and/or registered cryptographically. In some embodiments, DIDs 152 are bound to DPKI metadata 162 through verifiable data registries 136. Each DID 152 may refer to any subject such as a person, an organization, a thing, an abstract entity, etc. For example, DIDs 152 may be associated with one or more users 122, assets 224, services 126, hybrid legal contracts 154, hybrid general ledgers 156, hybrid journal entries 158, etc. In certain embodiments, DIDs 152 are generated for their subjects according to a programmed algorithm. In certain embodiments, DIDs 152 include autonomic identifiers (AIDs) based on Key Event Receipt Infrastructure (KERI). In the illustrated embodiment of FIG. 1, DIDs 152 of system 100 include DID 152a, DID 152b, DID 152c, and so on to DID 152n, where n represents any suitable integer.

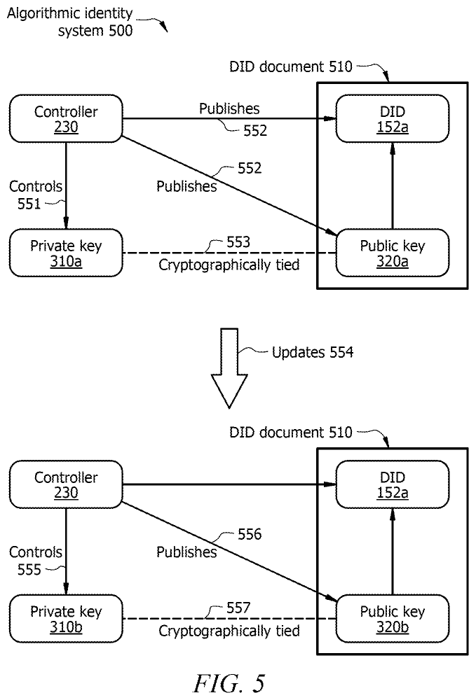

Hybrid legal contracts 154 of system 100 represent legal documents that exist partly as legal prose (natural language) and partly as computer code such that they are both human-readable and machine-readable. For example, hybrid legal contracts 154 may combine legal prose, DIDs 152, data 160, logical functions 172, and computation from decentralized application 150. Hybrid legal contracts 154 may include asset purchase agreements, copyright licenses, real estate property leases, mineral rights leases, employment agreements, corporate governance documents, copyright split sheets, wills, service provider documents, a combination thereof, or any other suitable legal document. In the illustrated embodiment of FIG. 1, hybrid legal contracts 154 of system 100 include hybrid legal contract 154a, hybrid legal contract 154b, hybrid legal contract 154c, and so on to hybrid legal contract 154n, where n represents any suitable integer. Hybrid legal contracts 154 are discussed in more detail in FIG. 9 below.

Hybrid general ledgers 156 of system 100 represent the status of accounts within a chart of accounts of user 122 based on transactions that are classified by hybrid journal entries 158. In the illustrated embodiment of FIG. 1, hybrid general ledgers 156 include hybrid general ledger 156a, hybrid general ledger 156b, hybrid general ledger 156c, and so on to hybrid general ledger 156n, where n represents any suitable integer.

Hybrid journal entries 158 of system 100 represent accounting journal entries that exist partly as accounting prose (natural language) and partly as computer code such that they are both human-readable and machine-readable. For hybrid journal entries 158, natural language is combined with a data model and markup language to create structured hybrid journal entries 158 that record the impact of a transaction on various accounts (e.g., accounts used in a double-entry bookkeeping process). By sharing a data model with hybrid legal contracts 154, hybrid journal entries 158 can classify a transaction and/or maintain consistency with the legal relationship that gives rise to the financial right or obligation that is classified in hybrid journal entries 158. Similar to hybrid legal contracts 154, hybrid journal entries 158 may link to DIDs 152 in a shared data model. In the illustrated embodiment of FIG. 1, hybrid journal entries 158 include hybrid journal entry 158a, hybrid journal entry 158b, hybrid journal entry 158c, and so on to hybrid journal entry 158n, where n represents any suitable integer.

Data 160 of system 100 represents information that has been translated into a form that is efficient for movement or processing. Data 160 may include sequences of one or more symbols and/or characters. In certain embodiments, data 160 includes metadata, which helps translate data 160 to information. In the illustrated embodiment of FIG. 1, data 160 includes DPKI metadata 162, training data 164, and financial data 166.

DPKI metadata 162 of system 100 represents sets of data that describe the subjects of DIDs 152. In certain embodiments, DPKI metadata 162 includes mechanisms (e.g., cryptographic public keys) that the subjects of DIDs 152 or authorized delegates use to authenticate themselves and/or prove their associations with DIDs 152. In certain embodiments, DPKI metadata 162 for a given DID 152 is accessible via a verifiable data registry 136. DPKI metadata 162 may include information for interacting with DIDs 152, key event logs associated with KERI frameworks and AIDs, resources such as the address of a location on network 110 where data 160 and messages can be routed and/or stored, etc. These messages and data 160 may be encrypted with a public key used by controller 230 of DID 152 for authentication, which allows for encrypted peer-to-peer (P2) message, encrypted data transmission, and/or encrypted storage while at rest. Within DPKI metadata 162 associated with DIDs 152, nodes (e.g., service endpoints) of network 110 may reference locations on network 110 where data 160 is to be stored under the control of DIDs 152. In the illustrated embodiment of FIG. 1, DPKI metadata 162 includes DPKI metadata 162a, DPKI metadata 162b, DPKI metadata 162c, and so on to DPKI metadata 162n, where n represents any suitable integer.

Training data 164 of system 100 represents data 160 used to train one or more machine learning algorithms or models. In certain embodiments, training data 164 requires human involvement to analyze and/or process the data for machine learning use. In some embodiments, training data 164 is used to teach prediction models that use machine learning algorithms how to extract features that are relevant to legal transactions. In the illustrated embodiment of FIG. 1, training data 164 includes training data 1640a, training data 164b, training data 164c, and so on to training data 164n, where n represents any suitable integer.

Financial data 166 of system 100 is information associated with one or more financial transactions. For example, financial data 166 may include one or more transaction dates, transaction amounts, account descriptions, account numbers, reference numbers, brief descriptions of the transaction, financial settlement information, and the like. In the illustrated embodiment of FIG. 1, financial data 166 includes financial data 166a, financial data 166b, financial data 166c, and so on to financial data 166n, where n represents any suitable integer.

Logic 170 of system 100 is executable software logic. In certain embodiments, logic 170 implements the business and/or legal logic that is memorialized in hybrid legal contracts 154. Logic 170 may be held within hybrid legal contracts 154 as one or more logical functions 172. Logic 170 may be executed across different compute environments 174. In some embodiments, logic 170 acts as logical function 172 that can be “called” with input values. In certain embodiments, logic 170 includes custom logic (e.g., contracting party custom logic or third-party custom logic), legal logic, etc. Logic 170 is discussed in more detail in FIG. 9 below. In the illustrated embodiment of FIG. 1, logic 170 includes logic 170a, logic 170b, logic 170c, and so on to logic 170n, where n represents any suitable integer.

Logical functions 172 of system 100 use certain data 160 as inputs, run computations, and/or generate one or more outputs. Logical functions 172 may reside in many different compute environments 174. In certain embodiments, logical functions 172 are used to perform comparisons on data 160. In some embodiments, logical functions 172 specify logical tests to be performed. In the illustrated embodiment of FIG. 1, logical functions 172 include logical functions 172a, logical functions 172b, logical functions 172c, and so on to logical functions 172n, where n represents any suitable integer.

Compute environments 174 of system 100 represent sets of managed and/or unmanaged computed resources that are used to perform actions. The compute resources of compute environments 174 may include devices 120, application server 140, distributed ledgers 132, etc. In the illustrated embodiment of FIG. 1, compute environments 174 include compute environment 174a, compute environment 174b, compute environment 174c, and so on to compute environment 174n, where n represents any suitable integer.

In operation, DIDs 152 of system 100 are derived from asymmetric key cryptography for one or more users 122, assets 124, services 126, and/or hybrid legal contracts 154. Decentralized application 150 uses DIDs 152 and DPKI metadata 162 to route messages, data, financial information, and the like, across network 110. DIDs 152 of users 122 and/or assets 124 that are involved in transactions are integrated into hybrid legal contracts 154 and hybrid journal entries 158, which turns hybrid legal contracts 154 into communication nodes in network 110. Hybrid legal contracts 154 and hybrid journal entries 158 share data 160 to maintain consistency between legal, financial, and accounting functions. Decentralized application 150 assists users 122 in converting data 160 (e.g., legal, financial, and/or accounting data) into structured data 160 that is stored in data stores 130 at the direction of users 122. Application server 140 is granted permission to access structured data 160 (including training data 164) held in data stores 130. Application server 140 applies machine learning techniques to training data 164 to produce models that assist users 122 with transactions. As such, system 100 allows for peer-to-peer transacting and client-side data aggregation of legal, financial, and/or accounting information, which reduces transaction costs that are often associated with legal contracting.

Although FIG. 1 illustrates a particular number of systems 100, networks 110, devices 120, users 122, assets 124, services 126, data stores 130, distributed ledgers 132, repositories 134, verifiable data registries 136, application servers 140, application interfaces 142, decentralized applications 150, DIDs 152, hybrid legal contracts 154, hybrid general ledgers 156, hybrid journal entries 158, data 160, logic 170, logical functions 172, and compute environments 174, this disclosure contemplates any suitable number of systems 100, networks 110, devices 120, users 122, assets 124, services 126, data stores 130, distributed ledgers 132, repositories 134, verifiable data registries 136, application servers 140, application interfaces 142, decentralized applications 150, DIDs 152, hybrid legal contracts 154, hybrid general ledgers 156, hybrid journal entries 158, data 160, logic 170, logical functions 172, and compute environments 174.

Although FIG. 1 illustrates a particular arrangement of network 110, devices 120, users 122, assets 124, services 126, data stores 130, distributed ledgers 132, repositories 134, verifiable data registries 136, application server 140, application interface 142, decentralized application 150, DIDs 152, hybrid legal contracts 154, hybrid general ledgers 156, hybrid journal entries 158, data 160, logic 170, logical functions 172, and compute environments 174, this disclosure contemplates any suitable arrangement of network 110, devices 120, users 122, assets 124, services 126, data stores 130, distributed ledgers 132, repositories 134, verifiable data registries 136, application server 140, application interface 142, decentralized application 150, DIDs 152, hybrid legal contracts 154, hybrid general ledgers 156, hybrid journal entries 158, data 160, logic 170, logical functions 172, and compute environments 1740.

Furthermore, although FIG. 1 describes and illustrates particular components, devices, or systems carrying out particular actions, this disclosure contemplates any suitable combination of any suitable components, devices, or systems carrying out any suitable actions.

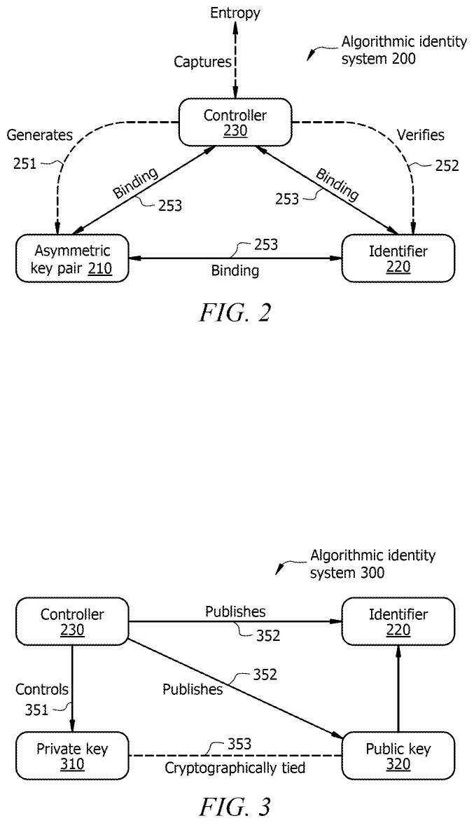

FIGS. 2 through 6 show different embodiments of algorithmic identity systems 200 through 600, respectively. Algorithmic identity systems 200 through 600 are used to manage relationships between different elements. In certain embodiments, algorithmic identity systems 200 through 600 may follow the World Wide Web Consortium's (W3C) Decentralized Identifier Specification. In this framework, DIDs are Uniform Resource Identifiers (URIs) that associate a DID subject (a person, organization, or thing) with a DPKI metadata object known as a DID document 510 that is controlled by a controller 230. In certain embodiments, the DID subject is the same person, organization, or thing as controller 230. In some embodiments, the DID subject is different than the person, organization, or thing of controller 230. In certain embodiments, DIDs 152 are associated with DPKI metadata through a verifiable data registry (e.g., verifiable data registries 136 of FIG. 1).

FIG. 2 illustrates an example algorithmic identity system 200 used to create a self-certifying identifier 220. Algorithmic identity system 200 includes controller 230, an asymmetric key pair 210, and identifier 220. Identifier 220 of system 200 is a self-certifying identifier that is unique within some namespace. The namespace provides context to identifier 220. DID controller 230 of system 200 is an entity that has the capability to make changes to DPKI metadata (e.g., a DID document or key event log). A DID may have more than one controller 230. Controller(s) 230 may be denoted by the optional controller property at the top level of the DPKI metadata. In certain embodiments, controller 230 manages identifier 220. In some embodiments, controller 230 makes authoritative statements about identifier 220 by virtue of knowing the authentication factors (e.g., asymmetric key pair 210).

Asymmetric key pair 210 of system 100 represents a mathematically related pair of keys that includes a public key (e.g., public key 320 of FIG. 3) and a private key (e.g., private key 310 of FIG. 3) for encryption and/or decryption. In certain embodiments, the public key of asymmetric key pair 210 is used for encryption, and the related private key is used for decryption. In some embodiments, the private key of asymmetric key pair 210 is used for encryption, and the related public key is used for decryption.

In algorithmic identity system 200, controller 230 of identifier 220 generates (see notation 251) authentication factors in the form of asymmetric key pair 210. In the illustrated embodiment of FIG. 2, asymmetric key pair 210 is an asymmetric public-private key pair. In certain embodiments, the public key or a unique fingerprint of the public key (through hashing, encoding, etc.) becomes identifier 220 or a prefix within identifier 220. In certain embodiments, a series of prefixes constituting entire identifier 220 provide context to a specific namespace.

In the illustrated embodiment of FIG. 2, controller 230 verifies (see notation 252) identifier 220. For example, the generation of asymmetric key pair 210 may create a type of self-certifying identifier 220 since identifier 220 is cryptographically tied to asymmetric key pair 210 (e.g., a specific public-private key pair) that is unique within a given namespace. Identifier 220 may certify itself by digitally signing a challenge message with the private key associated with the public key that is cryptographically bound to identifier 220. FIG. 2 illustrates these bindings (see notations 253) between controller 230, asymmetric key pair 210, and identifier 220.

FIG. 3 illustrates an algorithmic identity system 300 that includes controller 230, identifier 220, private key 310, and public key 320. Controller 230 of algorithmic identity system 300 controls (see notation 351) private key 310. As illustrated in the embodiment of FIG. 3, controller 230 publishes (see notations 352) public key 320 and identifier 220 (e.g., a self-certifying identifier) to authenticate identifier 220 to users (e.g., third parties) using associated private key 310. Private key 310 is cryptographically tied (see notation 353) to public key 320.

FIG. 4 illustrates an algorithmic identity system 400 that includes controller 230, identifier 220, public key 320, and verifiable data registry 136. Controller 230 of algorithmic identity system 400 generates (see notation 451) public key 320 and then derives (see notation 452) identifier 220. Controller 230 verifies (see notation 453) identifier 220. In certain embodiments, algorithmic identity system 400 uses verifiable data registry 136 to register (see notation 454) the binding (see notations 455) between identifier 220 and DPKI metadata about identifier 220 (including public key 320). In certain embodiments, verifiable data registry 136 is used for authenticating controller 230 that has cryptographic control over identifier 220.

In certain embodiments, verifiable data registry 136 provides global ordering and replicated state. This replicated state may be a key:value store (where the key is identifier 220 and the value is the DPKI metadata) or a location of the DPKI metadata associated with identifier 220. In certain embodiments, to rotate the public key material used for authentication, controller 230 updates the DPKI metadata associated with identifier 220 using transactions on verifiable data registry 136. The transaction history of verifiable data registry 136 may provide a transparent and tamper-evident mechanism for users (e.g., relying parties) to validate key management operations and the “key state” of identifier 220. Verifiable data registry 136 thus acts as a registry for the bindings (see notations 455) represented in FIG. 4.

The DPKI metadata associated with identifier 220 registered on verifiable data registry 136 may include resources in addition to public key material used for authentication. For example, the DPKI metadata may include service endpoints that allows messages and/or data to be routed to a location on a network as specified by controller 230 of identifier 220. In certain embodiments, these messages and/or data are encrypted/decrypted using the public key material found in the DPKI metadata.

FIG. 5 illustrates algorithmic identity system 500 that includes controller 230, identifier 220, private keys 310 (a first private key 310a and a second private key 310b), public keys 320 (a first public key 320a and a second public key 320b), a DID document 510, and DID 152a. Controller 230 of DID 152a controls (see notation 551) private key 310a and publishes (see notations 552) DID 152a and public key 320a. Public key 320a and private key 310a are cryptographically tied (see notation 553). In certain embodiments, DID 152a is registered on a verifiable data registry (e.g., verifiable data registry 136 of FIG. 4) along with DID document 510 (or a location of DID document 510), which provides the binding between DID 152a, public key 320a, and private key 310a.

In the illustrated embodiment of FIG. 5, controller 230 updates (see notation 554) DID document 510. For example, controller 230 may update DID document 510 using various techniques involving transactions with a verifiable data registry. Controller 230 of algorithmic identity system 500 controls (see notation 555) updated private key 310b and publishes (see notations 556) updated public key 320b. Public key 320b and private key 310b are cryptographically tied (see notation 557). This allows controller 230 to rotate the public key material found in the DPKI metadata associated with DID 152a without modifying DID 152a itself.

FIG. 6 illustrates algorithmic identity system 600 that includes controller 230, private key 310b, public key 320b, DID document 510, DID 152a, and a Uniform Resource Locator (URL) 610. Controller 230 of DID 152a controls (see notation 651) private key 310b and publishes (see notations 652) public key 320b. Public key 320b and private key 310b are cryptographically tied (see notation 653).

In certain embodiments, DID document 510 includes references in addition to public key material used for authentication. For example, DID document 510 may have references to service endpoints or locations on a network (e.g., for peer-to-peer (P2P) messaging), data storage, other advanced functionality, and the like. These external resources may be linked to DID 152a to create a path. For example, as illustrated in FIG. 6, external resources may be linked to DID 152a via URL 610.

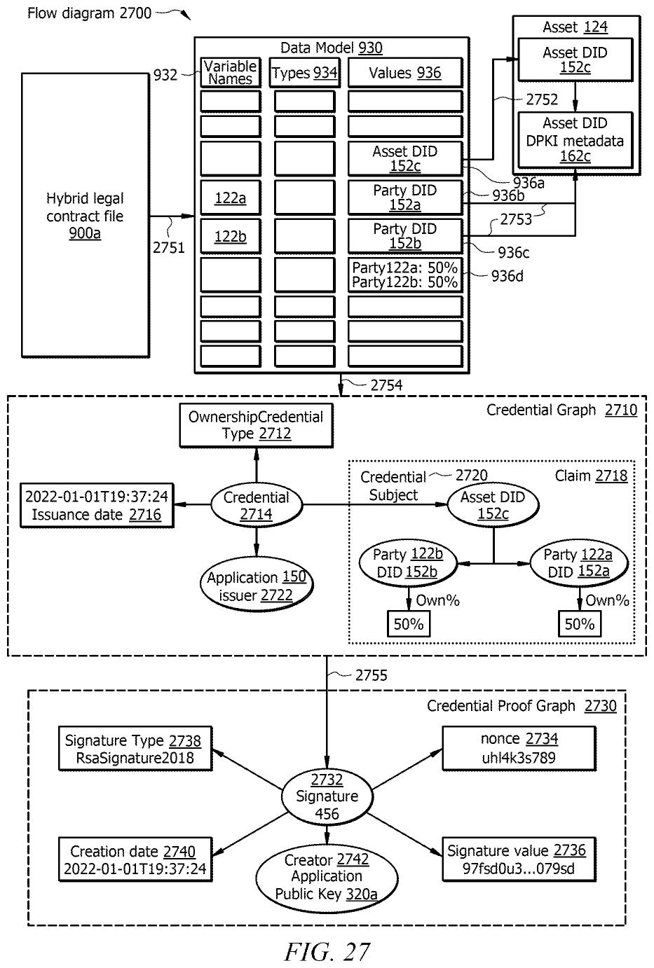

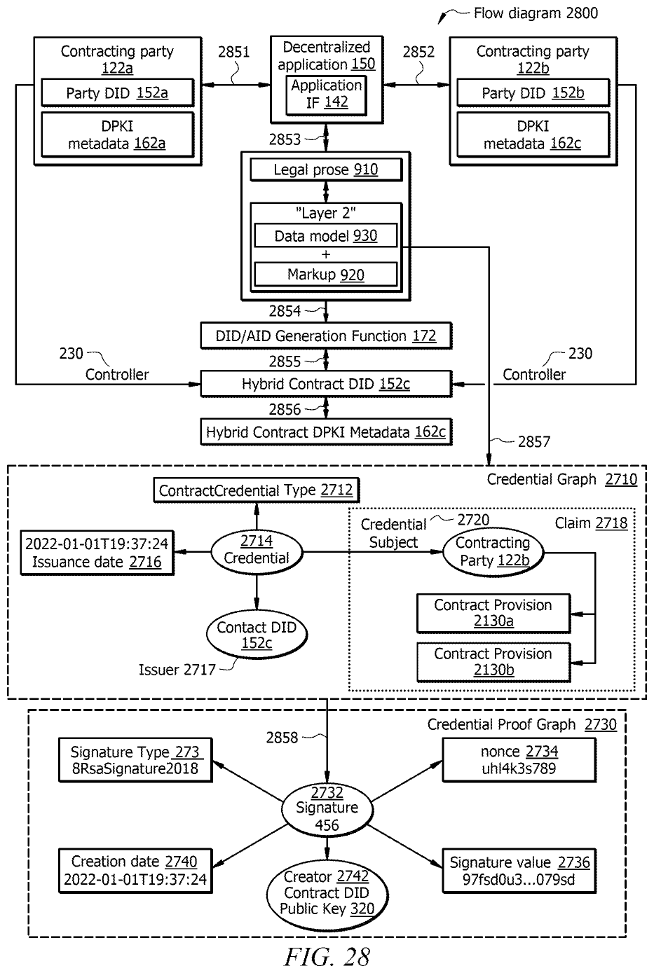

The W3C sponsors a specification for verifiable credentials based on digitally signed attestations made by one identifier (the issuer) about another identifier (the subject) that can be cryptographically verified by a third-party identifier (the verifier). The credential subject can possess this cryptographic credential or a separate identifier can possess it on behalf of the subject (a holder). Complex relationships between issuers, subjects, holders, and verifiers are possible with this framework. The identifiers used within the framework can be many different types, but DIDs 152 are the primary implementation. Verifiable data registries (e.g., verifiable data registries 136 of FIG. 4) are typically used to validate the bindings between a credential issuer's public key and the digital signature found on a credential issued by that issuer. Another type of verifiable credential that uses KERI-based AIDs is known as an authentic chained data container (ACDC). Both types of verifiable credentials may be used in decentralized application 150. Verifiable credentials (e.g., verifiable credential 2714), issuers (e.g., issuer 2722), subjects (e.g., credential subject 2720) are discussed further below in FIGS. 27 and 28.

Using verifiable credentials allows the creation of human-meaningful names that are cryptographically tied to the identifier (which itself is a string of random characters that is not human-meaningful). In certain embodiments, a verifiable credential is issued to each DID 152 that needs a human-meaningful identifier. The verifiable credential acts as a binding between the human-meaningful name and cryptographic-based DID 152. In certain embodiments, the verifiable credential is recorded on a verifiable name registry for easy searching of human-meaningful names. The verifiable credential can then be referenced to obtain associated DID 152a and/or DID document 510 for further actions.

Although FIGS. 2 through 6 illustrate a particular number of controllers 230, verifiable data registries 136, DIDs 152, asymmetric key pairs 210, identifiers 220, private keys 310, public keys 320, DID documents 510, and URLs 610, this disclosure contemplates any suitable number of controllers 230, verifiable data registries 136, DIDs 152, asymmetric key pairs 210, identifiers 220, private keys 310, public keys 320, DID documents 510, and URLs 610.

Although FIGS. 2 through 6 illustrate particular arrangements of controllers 230, verifiable data registries 136, DIDs 152, asymmetric key pairs 210, identifiers 220, private keys 310, public keys 320, DID documents 510, and URLs 610, this disclosure contemplates any suitable arrangement of controllers 230, verifiable data registries 136, DIDs 152, asymmetric key pairs 210, identifiers 220, private keys 310, public keys 320, DID documents 510, and URLs 610.

Furthermore, although FIGS. 2 through 6 illustrate and describe particular components, devices, or systems carrying out particular actions, this disclosure contemplates any suitable combination of any suitable components, devices, or systems carrying out any suitable actions.

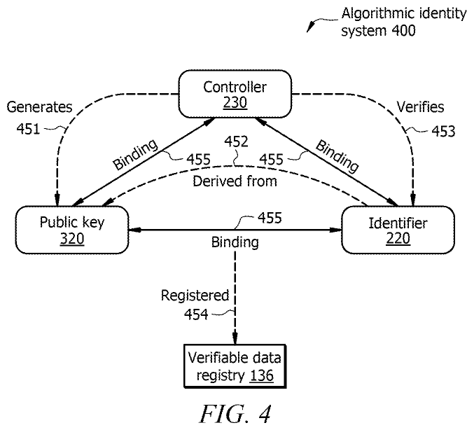

FIGS. 7 and 8 illustrate an autonomic identity system 800 and its associated key event log 700, in accordance with certain embodiments. Whereas algorithmic identity systems 200 through 600 rely on a hybrid root of trust that consists of operational infrastructure relating to a given verifiable data registry and cryptography in the form of asymmetric key pairs, autonomic identity system 800 relies on KERI that utilizes AIDs. AIDs have a single root of trust based solely on asymmetric key pairs. KERI is based on a verifiable data structure known as a key event log 700.

FIG. 7 illustrates key event log 700, in accordance with certain embodiments. Key event log 700 represents a hash-chained log of key events 710. Key events 710 of key event log 700 include key event 710a, key event 710b, and key event 710c. Key event 710a includes metadata 720a, hash digest 730a, and signatures 740a. Key event 710b includes metadata 720b, hash digest 730b, and signatures 740b. Key event 710c includes metadata 720c, hash digest 730c, and signatures 740c.

In certain embodiments, each autonomic identifier begins as a self-certifying identifier. The prefix of the self-certifying identifier may be derived from a public-private key pair as well as other metadata. In KERI, there are two main types of key events 710: (1) establishment events that establish control over the private key that acts as the root authority of the AID, and (2) non-establishment events for actions such as issuing a verifiable credential (e.g., ACDC) or digitally signing a message or transaction.

In the illustrated embodiment of FIG. 7, the first event in the life of an AID is first key event 710a in key event log 700. In certain embodiments, key event 710a is an establishment event known as an inception event. In the inception event, the controller (e.g., controller 230 of FIG. 2) assigns one or more public keys (e.g., multiple public keys for multi-signature capabilities) as the “signing key” and hash digest 730a of a second public key to be the “control key,” in addition to other metadata 720a. The inception event may be digitally signed with the signing key and may be published publicly and/or communicated privately to peers.

If next key event 710b is a non-establishment event, next key event 710b may be signed by the signing key and may include a hash of previous key event 710a (the inception event). Hash digest 730b cryptographically links key event 710a and key event 710b in a form of a “single account blockchain” such that all key events 710 include the hash of a previous key event 710. Key events 710 making up a key event log 700 are illustrated in FIG. 7.

If the private key half of the signing key is compromised, the controller may create a new establishment event known as a rotation event. In the rotation event, the previously hashed public key is revealed and becomes the new signing key, and the controller designates the hash of a new public key to be the new control key. The compromised key-pair is retired. Like other key events 710, this rotation event is hashed and included in next key event 710 to maintain a cryptographically linked key event log 700.

FIG. 8 illustrates an autonomic identity system 800, in accordance with certain embodiments. Autonomic identity system 800 includes controller 230, identifier 220, public key 320, key event log 700, and key events 710. Controller 230 of autonomic identity system 800 generates (see notation 851) public key 320 and then derives (see notation 852) identifier 220 from public key 320. Controller 230 verifies (see notation 853) identifier 220.

The combination of hashes for key events 710 and “pre-rotated” public keys provides a full sequence of control events relating to the controlling key pair of the AID. Rotation of the controlling key pair is essentially transferring the means by which root authority over the AID can be exercised. In certain embodiments, a history of these rotation events is used to prove the current key pair that has root authority. Any validator can thus obtain a copy of key event log 700 and verify that the history of cryptographic operations is correct, providing end-verifiability without any supporting infrastructure like a distributed ledger. This makes KERI's root of trust purely cryptographic. These bindings (see notations 854) are represented in FIG. 8.

Because key event logs 700 can be verified without reliance on any other infrastructure, controller 230 is free to use any selected method to make key event logs 700 available to verifiers who want to interact with and authenticate the AID. In effect, key event log 700 acts as its own verifiable data registry. In a peer-to-peer setting, controller 230 communicates key event logs 700 to its peer. If controller 230 wants to make key event logs 700 available to one or more users but controller 230 does not want to remain online to distribute key event logs 700, controller 230 may use various types of witness networks to forward key event logs 700 to one or more users (e.g., one or more verifiers). In certain embodiments, controller 230 creates human-meaningful identifiers that are cryptographically tied to the AID using a similar approach to the approaches discussed previously in FIGS. 2 through 6 with DIDs and verifiable names that are stored on a verifiable name registry.

Although FIGS. 7 and 8 illustrate a particular number of controllers 230, identifiers 220, public keys 320, key event logs 700, key events 710 (key event 710a, key event 710b, and key event 710c), metadata 720 (metadata 720a, metadata 720b, and metadata 720c), hash digests 730 (hash digest 730a, hash digest 730b, and hash digest 730c), and signatures 740 (signatures 740a, signatures 740b, and signatures 740c), this disclosure contemplates any suitable number of controllers 230, identifiers 220, public keys 320, key event logs 700, key events 710, metadata 720, hash digests 730, and signatures 740.

Although FIGS. 7 and 8 illustrate particular arrangements of controller 230, identifier 220, public key 320, key event log 700, key events 710, metadata 720, hash digests 730, and signatures 740, this disclosure contemplates any suitable arrangement of controller 230, identifier 220, public key 320, key event log 700, key events 710, metadata 720, hash digests 730, and signatures 740.

Furthermore, although FIGS. 7 and 8 illustrate and describe particular components, devices, or systems carrying out particular actions, this disclosure contemplates any suitable combination of any suitable components, devices, or systems carrying out any suitable actions.

FIG. 9 illustrates hybrid legal contract 154a, in accordance with certain embodiments. The concept of hybrid legal contract 154a is based on techniques allowing legal text to be both human-readable and machine-readable. In certain embodiments, hybrid legal contract 154a is different than a smart contract. For example, hybrid legal contract 154a has no requirement to implement logic on a blockchain. Hybrid legal contract 154a represents a legal document that exists partly as legal prose and partly as computer code so that hybrid legal contract 154a is both human readable and machine readable. In the illustrated embodiment of FIG. 9, hybrid legal contract 154 uses a legal prose 910, a markup language 920, a data model 930, and/or executable software logic 170 to generate hybrid legal contract file 900.

Legal prose 910 of hybrid legal contract 154a is a written form of natural language prose that follows the natural flow of speech. In certain embodiments, legal prose 910 uses ordinary grammatical structures of a language. Legal prose 910 may follow certain conventions of formal academic writing. In some embodiments, legal prose 910 creates legal obligations for one or more parties to hybrid legal contract 154a. Legal prose 910 may be in the form of a plaintext document.

Markup language 920 of hybrid legal contract 154a represents a text-encoding system that includes code inserted in legal prose 910 to control the structure, formatting, and/or relationship between the parts of legal prose 910. In certain embodiments, markup language 920 controls the display of legal prose 910. In some embodiments, markup language 920 is used to facilitate automated processing. For example, markup language 920 may use a set of rules to govern which markup information is included in legal prose 910 and/or how the markup information is combined with the content of legal prose 910 to facilitate use by humans and computer programs. Markup language 920 may include HyperText Markup Language (HTML), Extensible Markup Language (XML), Markdown, CommonMark, Keyhole Markup Language (KML), Mathematical Markup Language (MathML), Standard Generalized Markup Language (SGML), eXtensible Hypertext Markup Language (XHTML), a combination thereof, and the like.

In certain embodiments, legal prose 910 (e.g., a plaintext document) is provided structure and formatting capabilities. The structure allows parameters identified by markup language 920 to be pulled through to underlying data model 930 or schema. The formatting allows the text to be rendered into the legal contract “style” that is familiar to the legal industry (e.g., paragraphs, numbering, italics, etc.).

Data model 930 of hybrid legal contract 154a is an abstract model that organizes data elements and standardizes how they relate to one another. In certain embodiments, data model 930 is used to express the parameters that are contained within hybrid legal contract file 900 in a structured way. Hybrid legal contract 154a may implement an object-oriented schema framework as data model 930. For example, hybrid legal contract 154a may use a common object model framework such as JavaScript Object Notation (JSON), a framework based on JSON, XML, Go, a combination thereof, and the like. In certain embodiments, data model 930 provides structure and values to the deal points in legal prose 910 that are tagged as parameters to make legal prose 910 machine readable.

In the illustrated embodiment of FIG. 9, data model 930 includes the following parameters: variable names 932, data types 934, and values 936. Variable names 932 represent the name of the placeholder in markup language 920. For example, as shown in FIG. 9, variable names 932 may include variable name 932a (“licensee”), variable name 932b (“amount”), and variable name 932c (“licensor”).

Data types 934 include the types of data affiliated with each variable name 932. For example, variable name 932b representing “amount” may require a monetary value (e.g., an integer plus a currency code), whereas variable name 932a representing “licensee” and variable name 932c representing “licensor” may each require a string (e.g., a string of letters, an alphanumeric string, etc.). Data types 934 may include an integer, a string, an array, a monetary value, and the like.

With variable names 932 and data types 934, a user (e.g., user 122 of FIG. 1) may input values 936 to variable names 932. Values 936 represent what are actually displayed in legal prose 910 instead of variable name 932. For example, markup language 920 may include variable names 932 (Licensee, amount, and Licensor) as placeholders in the following sentence of legal prose 910, as illustrated in FIG. 9: “{{Licensee}} shall pay {{amount}} to {{Licensor}}”. A user can then input value 936a (Alice) for variable name 932a (Licensee) in accordance with data type 934a (string), input value 936b ($100) for variable name 932b (amount) in accordance with data type 934b (monetary), and input value 936c (Bob) for variable name 932c (Licensor) in accordance with data type 934c (string).

In certain embodiments, hybrid legal contract 154a is analogized to different layers (layer 1, layer 2, and layer 3) such that layer 1 represents legal prose 910, layer 2 represents markup language 920 and data model 930, and layer 3 represents executable software logic 170a. In some embodiments, values 936 are derived from and are consistent with legal prose 910 (layer 1). By using values 936 in data model 930 as inputs to logical functions (e.g., logical functions 172 of FIG. 1), executable software logic 170 in layer 3 may implement legal logic found within hybrid legal contract 154a. In certain embodiments, data model 930 (layer 2) ties legal prose 910 (layer 1) to executable software logic 170 (layer 3) to ensure consistency within the layers of hybrid legal contract 154a.

In certain embodiments, hybrid legal contract file 900 includes plaintext files for legal prose 910 that are annotated with markup language 920. Layer 3 of hybrid legal contract 900, executable software logic 170, may implement the business and/or legal logic that is memorialized in hybrid legal contract 154a. Executable software logic 170 may be held within hybrid legal contract file 900 as one or more logical functions 172. In certain embodiments, logical functions 172 use values 936 of data model 930 as inputs, run computations, and/or generate one or more outputs. Executable software logic 170 may be executed across different compute environments (e.g., compute environments 174 of FIG. 1). In some embodiments, executable software logic 170 acts as logical function 172 that can be “called” with input values, where logical function 172 may reside in many different compute environments.

Although FIG. 9 illustrates a particular number of hybrid legal contracts 154a, logic 170, logical functions 172, hybrid legal contract files 900, legal proses 910, markup languages 920, data models 930, variable names 932, data types 934, and values 936, this disclosure contemplates any suitable number of hybrid legal contracts 154a, logic 170, logical functions 172, hybrid legal contract files 900, legal proses 910, markup languages 920, data models 930, variable names 932, data types 934, and values 936.

Although FIG. 9 illustrates a particular arrangement of hybrid legal contract 154a, logic 170, logical functions 172, hybrid legal contract file 900, legal prose 910, markup language 920, data model 930, variable names 932, data types 934, and values 936, this disclosure contemplates any suitable arrangement of hybrid legal contract 154a, logic 170, logical functions 172, hybrid legal contract file 900, legal prose 910, markup language 920, data model 930, variable names 932, data types 934, and values 936.

Furthermore, although FIG. 9 illustrates and describes particular components, devices, or systems carrying out particular actions, this disclosure contemplates any suitable combination of any suitable components, devices, or systems carrying out any suitable actions.

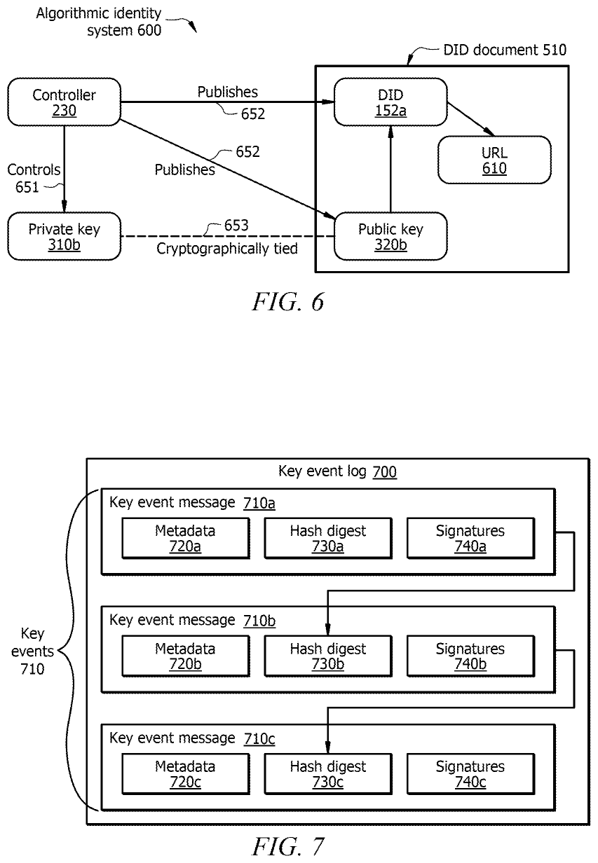

FIGS. 10 and 11 illustrate flow diagrams for generating a hybrid legal contract file using a unilateral framework. A unilateral process may occur in several different circumstances. For example, a unilateral process may occur when one counterparty to a legal prose contract 1010 that is still in force wants to convert legal prose contract 1010 into hybrid legal contract file 900, but the other counterparty to legal prose contract 1010 does not have a DID or does not want to convert legal prose contract 1010 into hybrid legal contract file 900. As another example, a unilateral process may occur if a contracting party wants to process legal prose contract 1010 that is no longer in force in order to generate insights from legal prose contact 1010. As still another example, a unilateral process may occur if a user wishes to turn existing corporate governance documents (e.g., written consents of a board of directors) into hybrid consents that can be translated into verifiable credentials relating to corporate authority. Regardless of the circumstance, a contracting party may use flow diagram 1000 to turn the unstructured, static information into dynamic, structured information for purposes of contract analysis and management.

Flow diagram 1000 of FIG. 10 incudes legal prose contract 1010, machine learning algorithms 1020, verifiable data registries 136, and classifications 1040. Legal prose contract 1010 of flow diagram 1000 is a natural language contract that follows the natural flow of speech. In certain embodiments, legal prose contract 1010 uses ordinary grammatical structures of a language. Legal prose contract 1010 may follow certain conventions of formal academic writing. In some embodiments, legal prose contract 1010 creates legal obligations for one or more parties to hybrid legal contract 154a. Legal prose contract 1010 may be in the form of a plaintext document.

Machine learning algorithms 1020 are methods by which the artificial intelligence (AI) system conducts tasks. In certain embodiments, machine learning algorithms 1020 predict output values from given input data (e.g., training data 164 of FIG. 1). Machine learning algorithms 1020 may use classification processes, regression processes, and the like. In certain embodiments, one or more machine learning algorithms 1020 are used to generate hybrid legal contract file 900 and/or hybrid journal entries (e.g., hybrid journal entries 158 from FIG. 1) from pre-existing legal prose contract 1010.

In the illustrated embodiment of FIG. 10, machine learning algorithms 1020 utilize one or more classification engines 1040 to classify portions of legal prose contract 1010. Classification engine 1040 may classify portions of legal prose contract 1010 based on a document type, a clause type, an identity of a party, a subject of a legal document, and so on. In the illustrated embodiment of FIG. 10, classification engines 1040 include an identifier classification engine 1040a, a document classification engine 1040b, a clause classification engine 1040c, a data model classification engine 1040d, a logic classification engine 1040e, and a journal entry classification engine 1040f.

Identifier classification engine 1040a of classification engines 1040 classifies and/or resolves identifiers (e.g., DIDs 152 of FIG. 1). For example, identifier classification engine 1040a may classify an identity within the legal prose and then resolve a DID to obtain the DID Document (e.g., DPKI metadata). As another example, identifier classification engine 1040a may input a DID to produce a DID document from whatever underlying verifiable data registry maintains the bindings to the DPKI metadata.

Document classification engine 1040b of classification engines 1040 classifies different types of documents by document type. For example, document classification engine 1040b may classify legal prose contract 1010 as an asset purchase agreement, a license (e.g., synchronization license), a will, a lease (e.g., a real estate lease), and so on.

Clause classification engine 1040c of classification engines 1040 classify different types of clauses within legal prose contract 1010. For example, clause classification engine 1040c may classify different portions of legal prose contract 1010 into one or more of the following clauses: a license grant clause (e.g., a grant of rights), an indemnity clause, an arbitration clause, a force majeure clause, an escalation clause, a confidentiality clause, a non-compete clause, an intellectual property rights clause, warranty clause, a payment clause, a term/termination clause, and the like.

Data model classification engine 1040d of classification engines 1040 classifies the components of a data model (e.g., variable names 932, data types 934, and values 936 of data model 930 of FIG. 9) used to generate hybrid legal contract file 900.

Logic classification engine 1040e of classification engines 1040 classifies the logic (e.g., logic 170 of FIG. 9) used to generate hybrid legal contract file 900. For example, if legal prose contract 1010 includes ongoing legal logic that can be automated, machine learning algorithm 1020 may be trained to classify logic within legal prose contract 1010 itself. Once classified, machine learning algorithms 1020 may search a logic repository for potential code that can be executed in a compute environment (e.g., compute environment 174 of FIG. 1) in order to automate the logic. However, not all legal prose contracts 1010 will have ongoing logic, whether the contract is still in force or has already been terminated, making this task optional. The logic can use the parameters in the data model as inputs to the logical functions, as discussed previously in FIG. 9.

Journal entry classification engine 1040f of classification engines 1040 classifies the components of hybrid journal entries (e.g., hybrid journal entries 158 of FIG. 9). To automatically generate hybrid journal entries 158 directly from legal prose contract 1010, the structured data may be pulled from the shared data model. For components of the hybrid journal entries that are not directly derived from the data model, document classification engine 1040b and clause classification engine 1040c may generate the necessary accounting prose. For example, document classification engine 1040b may be used to populate the transaction summary, while the identities listed in the transaction summary can be linked to their DIDs in the shared data model through the markup language.

In certain embodiments, machine learning algorithms 1020 train one or more classification engines 1040 separately. In some embodiments, machine learning algorithms 1020 simultaneously train one or more classification engines 1040. For example, machine learning algorithms 1020 may simultaneously train one or more classification engines 1040 using techniques such as multi-output architectures, multitask learning, etc.

In certain embodiments, one or more classification engines 1040 may be broken down into subtasks. For example, machine learning algorithms 1020 may use data model classification engine 1040d to classify the markup language (e.g., markup language 920 of FIG. 9) that will apply to legal prose contract 1010 and generate a markup version 1012 (see notation 1051) of a given clause or entire legal prose contract 1010.

At step 1051 of flow diagram 1000, legal prose contract 1010 is input into machine learning algorithms 1020. At step 1052 of flow diagram 1000, machine learning algorithms 1020 classify the markup language variable names with their data types in a shared data model. At step 1053 of flow diagram 1000, machine learning algorithms 1020 search one or more verifiable data registries 136 for the various identities (e.g., DIDs 152 of FIG. 1) to be included in legal prose contract 1010. In certain embodiments, verifiable name registries 136 include a key:value store where the natural language names (e.g., full legal names of users and assets) are the key and an associated DID is the value. Multiple natural language prose names that are the same can be distinguished with verifiable credentials and other information. In certain embodiments, if a DID is available, machine learning algorithm 1020 obtains the DID and populates the DID in the shared data model. If a given identity in legal prose contract 1010 does not have a DID, machine learning algorithm 1020 may flag this determination for later processing. Machine learning algorithm 1020 may alert the user to this determination and guide the user in creating a DID, if applicable. At step 1054 of flow diagram 1000, machine learning algorithms 1020 populate the parameters for the data model from the legal prose to generate hybrid legal contract file 900. At step 1055 of flow diagram 1000, markup version 1012 is communicated to hybrid legal contract file 900.

FIG. 11 illustrates a more detailed flow diagram 1100 for generating hybrid legal contract file 900 using a unilateral framework, in accordance with certain embodiments. Flow diagram 1100 includes steps 1151 through 1159. At step 1151 of flow diagram 1100, a contracting party 122a to legal prose contract 1010 is associated with DID 152a and DPKI metadata 162a. At step 1152 of flow diagram 1100, a user (e.g., contracting party 122a) uploads legal prose contract 1010 or a batch of legal prose contracts 1010 to application interface 142 for processing. Legal prose contracts 1010 may be electronic versions in various formats (e.g., PDF or Microsoft Word), scans that are converted into electronic versions (e.g., with optical character recognition (OCR)), and the like. Decentralized application 150 may use one or more machine learning algorithms (e.g., machine learning algorithms 1020 of FIG. 10) to perform compound classification and/or generation of the components of hybrid legal contract file 900 and associated hybrid journal entry 158a.

At step 1153 of flow diagram 1100, the one or more algorithms extract identities within legal prose contract 1010 as part of the classification process. In certain embodiments, decentralized application 150 cross-references verifiable data registry 136 to obtain DIDs 152 (asset DID 152b and/or service provider DID 152c) that are the subject of legal prose contract 1010. If there is no asset DID 152b or service provider DID 152c classified by classification engines 1040, contracting party 122a may be alerted. In certain embodiments, decentralized application 150 assists contracting party 122a in creating asset DID 152b and setting DID 152a as the controller (e.g., controller 230 of FIG. 1) of asset DID 152b in the event contracting party 122a is the owner of the asset in the “real world.” Asset DID 152b and the asset name can then be added verifiable name registry 136.

At step 1154 of flow diagram 1100, decentralized application 150 populates data model 930 using the parameters extracted by classification engines 1040. At step 1155 of flow diagram 1100, decentralized application 150 populates hybrid legal contract file 900, which may include original legal prose contract 1010, a markup language and data model, and/or any logic implemented in code that contracting party 122a would like to include. At step 1156 of flow diagram 1100, decentralized application 150 populates hybrid journal entry 158a based on parameters in shared data model 930 and/or information generated by classification engines 1040.

At step 1157 of flow diagram 1100, both data structures (hybrid legal contract file 900 and hybrid journal entry 158a) are routed back to application interface 142 for review by contracting party 122a (user review 1110). At step 1158 of flow diagram 1100, the user performs an iterative process to correct any errors made by classification engines 1040. At step 1159 of flow diagram 1100, once contracting party 122a has finalized hybrid legal contract file 900 and hybrid journal entry 158a, application interface 142 routes hybrid legal contract file 900 and hybrid journal entry 158a back to a location as set forth in DPKI metadata 162a of contracting party 122a. In certain embodiments, one or more application servers (e.g., application server 140 of FIG. 1) delete the data.

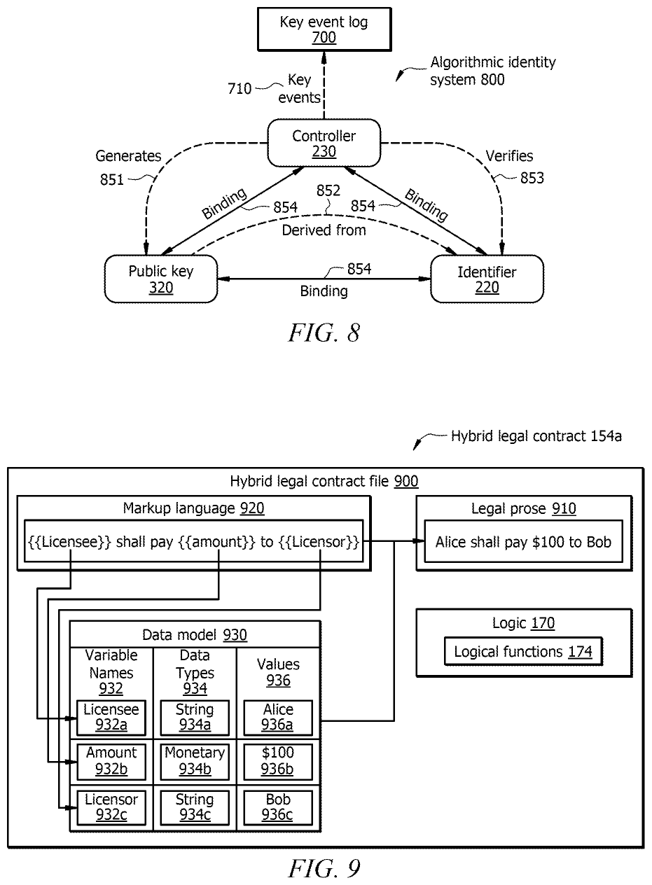

FIG. 12 illustrates flow diagram 1200 for generating hybrid legal contract files 900 using a multi-party framework, in accordance with certain embodiments. Flow diagram 1200 of FIG. 12 generates hybrid legal contract file 900 for contracting party 122a and contracting party 122b. Flow diagram 1200 includes steps 1251 through 1263.

At step 1251 of flow diagram 1200, contracting party 122a is associated with DID 152a and DPKI metadata 162a. At step 1252 of flow diagram 1200, decentralized application 150 receives legal prose contract 1010 from contracting party 122a. For example, contracting party 122a may use application interface 142 to upload legal prose contract 1010 or batch of legal prose contracts 1010 to decentralized application 150 for processing. At step 1253 of flow diagram 1200, decentralized application 150 uses classification engines 1040 to classify legal prose contract 1010 into one or more classifications. For example, classification engines 1040 may perform compound classification and/or generation of the components of hybrid legal contract file 900 and any associated hybrid journal entries 158a. As part of the classification process, classification engines 1040 may extract identities within legal prose contract 1010. In certain embodiments, decentralized application 150 obtains DIDs 152. For example, decentralized application 150 may cross-references verifiable name registry 136 to obtain DIDs 152 (contracting party DID 152a, contracting party DID 152b, and/or asset DID 152c) that are the subjects of legal prose contract 1010.

At step 1254 of flow diagram 1200, contracting party 122b is associated with DID 152b and DPKI metadata 162b. In certain embodiments, DID 152b is registered on verifiable name registry 136. Decentralized application 150 may cross-reference the legal name to obtain DID 152b. In the event contracting party 122b does not have an identifier, decentralized application 150 may alert contracting party 122a, who can contact contracting party 122b with instructions on how to create an identifier. In certain embodiments, decentralized application 150 invites contracting party 122b to create DID 152b and/or DPKI metadata 162b using application interface 142. Once contracting party 122b has DID 152b with DPKI metadata 162b and contracting parties 122a and 122b have authenticated each other, flow diagram 1200 continues to step 1255.

At step 1255 of flow diagram 1200, an application server (e.g., application server 140 of FIG. 1) determines that asset 124a is the subject of legal prose contract 1010. In the event DID 152c does not exist for asset 124a as classified by classification engines 1040, contracting parties 122a and 122b may be alerted by decentralized application 150. In certain embodiments, decentralized application 150 assists contracting parties 122a and 122b in creating DID 152c for asset 124a and setting contracting party DID 152 that owns asset 124a in the “real world” as controller 230. Asset DID 152c and the asset name may then be added to verifiable data registry 136. In flow diagram 1200, contracting party 122b is controller 230 of asset DID 152c based on contracting party 122b owning asset 124a.

At step 1256 of flow diagram 1200, decentralized application 150 generates data model 930 using one or more DIDs 152 and/or one or more classifications. For example, decentralized application 150 may populate data model 930 using the parameters extracted by classification engines 1040. At step 1257 of flow diagram 1200, decentralized application 150 generates (e.g., populates) hybrid legal contract file 900. Hybrid legal contract file 900 (as illustrated in FIG. 9) may include legal prose contract 1010, a markup language and data model, and/or any logic implemented in code.

At step 1258 of flow diagram 1200, decentralized application 150 populates hybrid journal entries 158a and 158b for both contracting parties 122a and 122b based on parameters in shared data model 930 and information generated by classification engines 1040 (e.g., journal entry classification engine 1400. At step 1259 of flow diagram 1200, both data structures (hybrid legal contract file 900 and hybrid journal entries 158 and 158b) are routed back to application interface 142 for review (user review 1110) by each contracting party 122a and 122b. At step 1260 of flow diagram 1200, contracting parties 122a and 122b perform an iterative process to correct any errors made by classification engines 1040. Both contracting parties 122a and 122b may make changes, communicate comments and/or questions, and/or take whatever steps are necessary to satisfy the pre-existing legal relationship when converting legal prose contract 1010 into hybrid legal contract file 900.

At step 1261 of flow diagram 1200, once contracting parties 122a and 122b have agreed to the “layer 1” natural language prose, the “layer 2” data model and markup, and/or any “layer 3” legal logic, entire hybrid legal contract file 900 may be digitally signed by contracting parties 122a and 122b if legal prose contract 1010 is still in force. After execution, hybrid legal contract file 900 is routed for storage based on information in contracting parties' DPKI metadata 162a and 162b. In certain embodiments, hybrid journal entries 158a are routed back for storage with applicable contracting party 122a or 122b.

At step 1262 of flow diagram 1200, any legal logic is moved into compute (execution) environment 174. In certain embodiments, step 1262 occurs simultaneously with the digital signature process. In some embodiments, step 1262 occurs at a time and date after the digital signature process. Once hybrid contract legal file 900 is signed, the source code implementing the logical functions (e.g., logical functions 172 of FIG. 1) are moved into compute environments 174 as agreed by contracting parties 122a and 122 and as documented in hybrid legal contract file 900.

At step 1263 of flow diagram 1200, decentralized application 150 creates a verifiable credential schema derived from data model 930 and schema of hybrid legal contract file 900. In certain embodiments, decentralized application 150 provides functionality for contracting parties 122a and 122b to issue the verifiable credential as needed by the contractual relationship. For example, if contracting party 122b, as owner of asset 124a, grants a license to contracting party 122a, as a licensee of asset 124a, the verifiable credential derived from data model 930 may be issued from DID 152b to DID 152a. As another example, decentralized application 150 may issue the verifiable credentials to contracting parties 122a and 122b (e.g., to DID 152a and DID 152b), who would act as holders of the verifiable credential(s).

In certain embodiments, hybrid legal contract file 900 is given its own DID 152 with contracting party DIDs 152a and 152b as controllers 230 of the contract DID and its associated DPKI metadata 162. This allows hybrid legal contract file 900 to issue verifiable credentials or respond to queries about its contents.

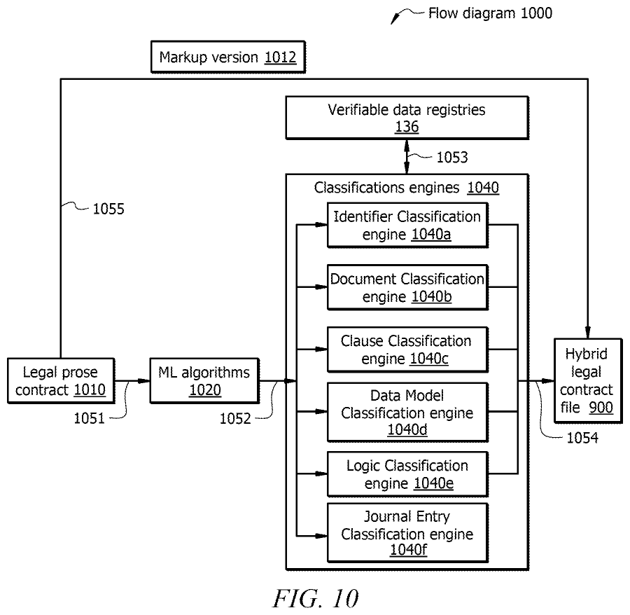

FIG. 13 illustrates a flow diagram 1300 for contracting party 122a to search for assets 124 with which to transact, in accordance with certain embodiments. Flow diagram 1200 includes steps 1351 through 1358.

At step 1351 of flow diagram 1300, contracting party 122a with DID 152a and DPKI metadata 162a communicates with application interface 142 to transact with the owners of assets 124 for the right to use and/or buy assets 124. In certain embodiments, contracting party 122a utilizes a user agent for key management and DPKI metadata management, which can be provided by decentralized application 150, third parties, etc.

At step 1352 of flow diagram 1300, contracting party 122a searches for one or more assets 124 with which to transact using one or more search methods 1300. Search methods 1300 include a reverse auction search method 1300a, a direct query search method 1300, and an asset search method 1300c. An example of reverse auction search method 1300a is illustrated at step 1353 of flow diagram 1300. Using reverse auction search method 1300a, contracting party 122a may submit a reverse auction or “cattle call” query that asks for submissions of potential assets 124 based on the needs of contracting party 122a. This request can then be stored on application server 140, on distributed ledger 132 (e.g., a blockchain or a distributed file storage service such as the InterPlanetary File System (IPFS)), directly within data store 130a (e.g., an identity hub of contracting party 122a), and the like. From there, as illustrated by steps 1354, the request may be subscribed to or crawled by interested asset owners who want to submit one or more assets as a response.

An example of direct query search method 1300a is illustrated at step 1355 of flow diagram 1300. Using direct query search method 1300b, contracting party 122a may search for particular asset 124a that is indexed and/or registered with decentralized application 150. In response to the direct query search request, as illustrated by step 1356, decentralized application 150 returns asset DID 152b based on the query.

An example of asset search method 1300a is illustrated at step 1357 of flow diagram 1300. Using asset search method 1300c, contracting party 122a may search for assets 124 based on various search parameters, such as a compound query with both asset characteristics and legal parameters. In response to the asset search request, as illustrated by step 1358, decentralized application 150 returns search results 1302 as a list of the top-ranking assets 124 (as represented by asset DIDs 152b) based on the compound query.

In certain embodiments, when one or more search methods 1300 are initiated, asset DIDs 152 are being resolved in the background by decentralized application 150 to obtain DPKI metadata 162 and/or associated service endpoints for routing messages, storing data, processing payments, etc. DPKI metadata 162 may be established by the asset owner DIDs 152 as the controllers of asset DIDs. In certain embodiments, resolution of DID 152 to obtain DID document or key event log (e.g., DPKI metadata 162a) is specific to a given DID or KERI-based method. In some embodiments, a universal resolver is used as an abstract function to take any DID 152 as an input and produce DPKI metadata 162a from a verifiable data registry. In certain embodiments, a key event log (see FIG. 7) is obtained from the witness (or witnesses) specified by the controller in the asset identifier's key event log inception statement.

In certain embodiments, decentralized application 150 resolves asset owner DIDs listed in the asset DPKI metadata to obtain DPKI metadata 162 associated with asset owner DIDs. In certain embodiments, a request to transact with asset 124 may be routed directly based on instructions in the asset DID's DPKI metadata. In some embodiments, a request to transact with asset 124 may be routed based on the asset owner DID's DPKI metadata. The routing on the request may depend on the privacy desired by the asset owners and whether they want their ownership interests to be publicly available.

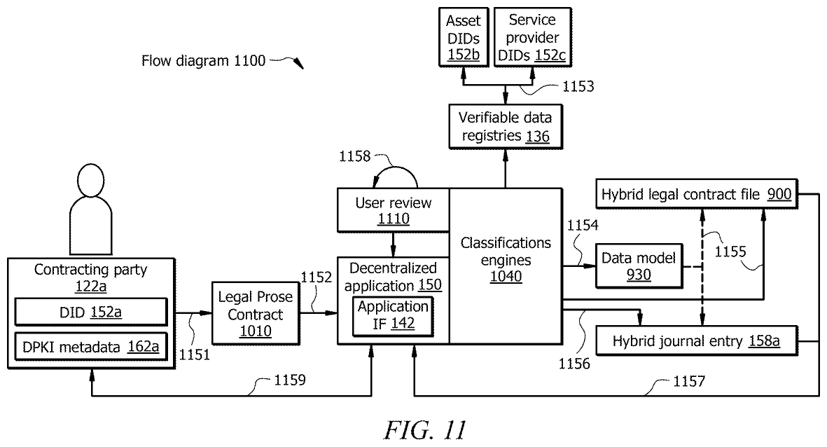

FIG. 14 illustrates a flow diagram 1400 for resolving asset owner DIDs 152b and 152c from asset DPKI metadata 162d, in accordance with certain embodiments. In flow diagram 1400, asset 124a is owned by two owners: asset owner 122b and asset owner 122c. In certain embodiments, one or more asset owners 122 may be administrators. Flow diagram 1200 includes steps 1451 through 1455.

At step 1451 of flow diagram 1400, contracting party 122a with DID 152a and DPKI metadata 162a communicates with application interface 142 to submit a request to transact with asset owners 122b and 122c for the right to use and/or buy asset 124a. At step 1452 of flow diagram 1400, decentralized application 150 dynamically routes the request based on information in asset DPKI metadata 162d (and optionally DPKI metadata 162b and 162c). At step 1453 of flow diagram 1400, decentralized application 150 receives asset owner DIDs 152b and 152c from asset DPKI metadata 162d. At step 1454 of flow diagram 1400, decentralized application 150 resolves asset owner DPKI metadata 162b and 162c.

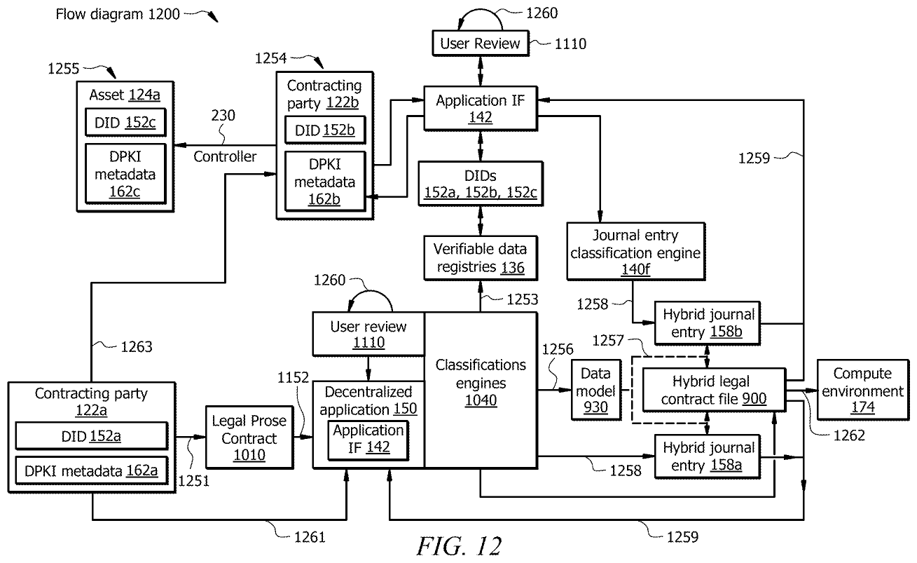

FIG. 15 illustrates a flow diagram 1500 for contracting party 122a to search for service providers 122b through 122n (where n represents any suitable integer) with which to transact, in accordance with certain embodiments. In some embodiments, one or more service providers 122b through 122n may be replaced with an employee. Service providers 122b through 122n may be associated with services (e.g., services 126 of FIG. 1). Flow diagram 1200 includes steps 1551 through 1558.

At step 1551 of flow diagram 1500, contracting party 122a with DID 152a and DPKI metadata 162a communicates with application interface 142 to submit a request to transact with service providers. At step 1552 of flow diagram 1500, contracting party 122a searches for one or more service providers 152b through 152n with which to transact using one or more search methods 1500. Search methods 1500 include a reverse auction search method 1500a, a direct query search method 1500b, and a service provider search method 1500c. An example of reverse auction search method 1500a is illustrated at step 1553 of flow diagram 1500. Using reverse auction search method 1500a, contracting party 122a may submit a reverse auction or “cattle call” query that asks for submissions of potential service providers 152b through 152n based on the needs of contracting party 122a. This request can then be stored on application server 140, on distributed ledger 132 (e.g., a blockchain or a distributed file storage service such as IPFS), directly within data store 130a (e.g., an identity hub of contracting party 122a), and the like. From there, as illustrated by steps 1554, the request may be subscribed to or crawled by interested service providers 152b through 152n who want to submit one or more services (e.g., services 126 of FIG. 1) as a response.

An example of direct query search method 1500b is illustrated at step 1555 of flow diagram 1500. Using direct query search method 1500b, contracting party 122a may search for specific service provider 122b that is indexed and/or registered with decentralized application 150. In response to the direct query search request, as illustrated by step 1556, decentralized application 150 returns service provider DID 152c associated with service provider 122b based on the query.

An example of service provider search method 1500c is illustrated at step 1557 of flow diagram 1500. Using service provider search method 1500c, contracting party 122a may search for service providers 122b through 122n based on various search parameters, such as a compound query with service/service provider characteristics and/or legal parameters. In response to the service provider search request, as illustrated by step 1558, decentralized application 150 returns search results 1502 as a list of the top-ranking service providers 122b through 122n (as represented by service provider DIDs 152b through 152n, respectively) based on the compound query.

In certain embodiments, when one or more search methods 1500 are initiated, service provider DIDs 152b through 152n are being resolved in the background by decentralized application 150 to obtain DPKI metadata and/or associated service endpoints for routing messages, storing data, processing payments, etc. The DPKI metadata may be established by service providers DIDs 152b through 152n as the controllers of service provider DIDs 152b through 152n. In certain embodiments, resolution of DIDs 152 to obtain DPKI metadata is DID-method specific. In certain embodiments, resolution of DID 152 to obtain a DID document or key event log (e.g., DPKI metadata 162) is specific to a given DID or KERI-based method. In some embodiments, a universal resolver is used as an abstract function to take any DID 152 as an input and produce DPKI metadata 162 from a verifiable data registry. In certain embodiments, a key event log (see FIG. 7) is obtained from the witness (or witnesses) specified by the controller in the asset identifier's key event log inception statement.

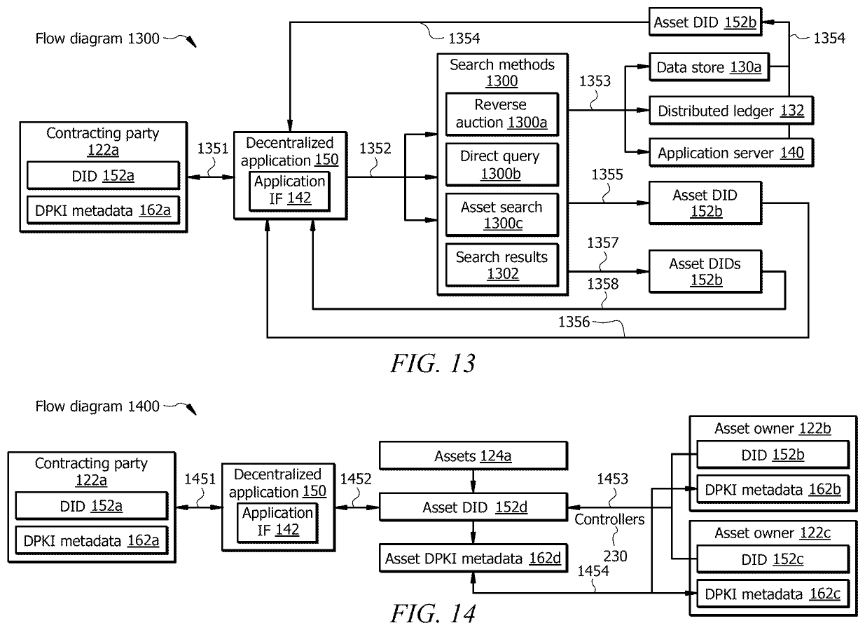

FIG. 16 illustrates a flow diagram 1600 for contracting party 122a to submit a transaction request to service provider 122b, in accordance with certain embodiments. In some embodiments, the service provider 122b may be replaced with an employee. Flow diagram 1600 includes steps 1651 through 1652.

At step 1651 of flow diagram 1600, contracting party 122a with DID 152a and DPKI metadata 162a communicates with application interface 142 to submit a request to transact with service provider 122b for a service (e.g., service 126a of FIG. 1). At step 1652 of flow diagram 1600, application interface 142 routes the transaction request to where service provider 122b (or potential employee) has specified in DPKI metadata 162b.

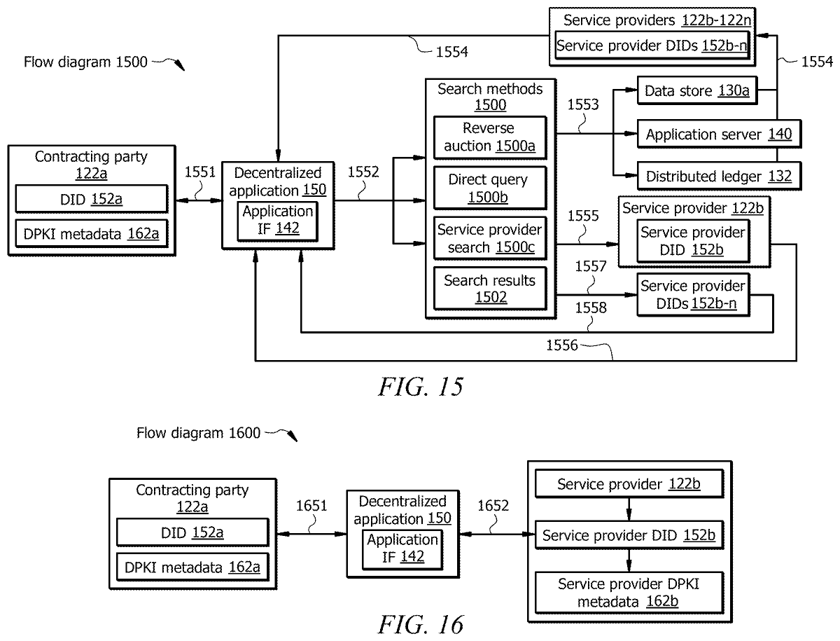

FIG. 17 illustrates a flow diagram 1700 for contracting party 122a to populate data model 930 for a transaction request, in accordance with certain embodiments. Flow diagram 1700 includes steps 1751 through 1756.

At step 1751 of flow diagram 1700, contracting party 122a with associated DID 152a and DPKI metadata 162a communicates with application interface 142 to submit a request to transact with users 122 (e.g., service providers, asset owners, etc.). At step 1752 of flow diagram 1700, decentralized application 150 has pre-processed standard form legal prose contracts 1010 used by users (e.g., asset owners or service providers) who will receive the transaction requests to create a hybrid legal contract files 900. The users (e.g., asset owners, service providers, licensors, etc.) may have their own preferred form legal prose contract that has been previously drafted and/or vetted by an in-house attorney, outside counsel, etc.

At step 1753 of flow diagram 1700, decentralized application 150 obtains empty data model 930b from hybrid legal contract file 900. In certain embodiments, empty data model 930b may have variable names and types but blank values. At step 1754 of flow diagram 1700, decentralized application 150 and application interface 142 present a transaction interface to contracting party 122a to assist in populating the “deal points” that generate the values in empty data model 930b. At step 1755 of flow diagram 1700, the inputs from contracting party 122a are populated into populated data model 930a. At step 1756, the values are populated into legal prose contract 1010 through the markup language.

Application interface 142 may present various options for contracting party 122a to submit the transaction request. In each of these options, the ask is to populate data model 930 with the contractual “deal points” that can then be integrated into legal prose contract 1010.

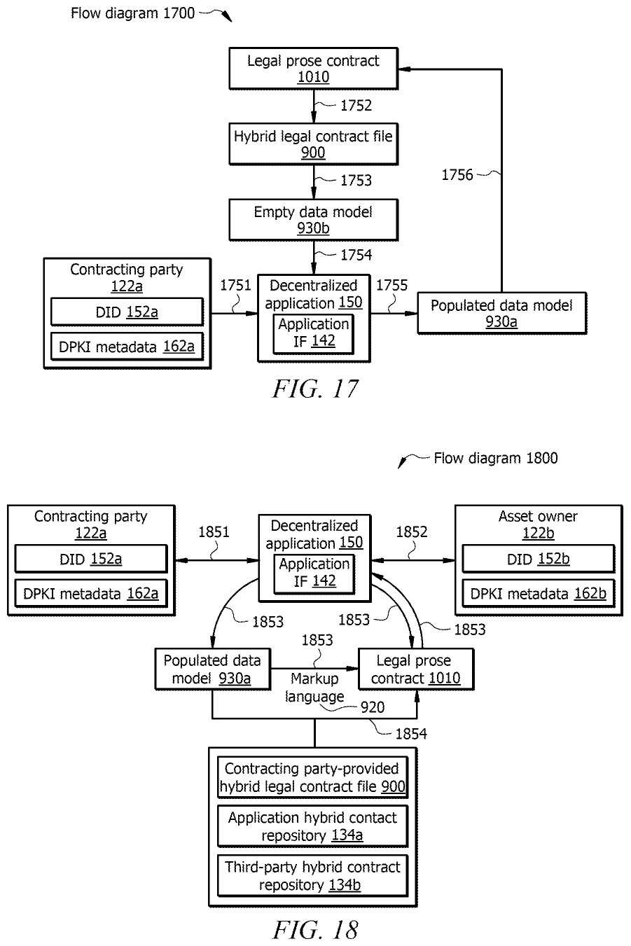

FIG. 18 illustrates a flow diagram 1800 for contracting party 122a to submit a transaction request to asset owner 122b, in accordance with certain embodiments. Flow diagram 1800 includes steps 1851 through 1855.

At step 1851 of flow diagram 1800, contracting party 122a with associated DID 152a and DPKI metadata 162a communicates with application interface 142 to submit a request to transact with asset owner 122b. At step 1852 of flow diagram 1800, decentralized application 150 routes the transaction request to where asset owner 122b (or potential employee) has specified in asset owner's DPKI metadata 162b.

At steps 1853 of flow diagram 1800, once contracting party 122a has populated the transaction request parameters in data model 930a, application interface 142 routes populated data model 930a back to asset owner DID 152b (or service provider DID) based on information in asset identifier's DPKI metadata 162b (or in the service provider identifier DPKI metadata if there is no separate asset involved).

At step 1854 of flow diagram 1800, once contracting party 122a and asset owner 122b have agreed on the data model parameters, the data model parameters are populated into legal prose contract 1010. Legal prose contract 1010 may be supplied from contracting party 122a, asset owner 122b, an application-based hybrid contract repository 134a, a third-party contract repository 134b, and the like.

Contracting party 122a and asset owner 122b negotiate and make changes to legal prose contract 1010 similar to how traditional contracts are edited. This process can occur by hosting hybrid legal contract file 900 (which at this point may only include the legal prose and the data model and markup language) on an application server, by trading changes in a peer-to-peer fashion, and the like. In certain embodiments, contracting party 122a and asset owner 122b may continue to edit legal prose contract 1010 even after finalizing the transaction request parameters in data model 930a.

In certain embodiments, all communications and negotiations relating to data model 930a (e.g., the data model parameters), legal prose 910, any legal logic that is included in hybrid legal contract file 90, and transaction workflow data may be maintained on an application server (e.g., application server 140 of FIG. 1) until the hybrid legal contract file is executed. Once executed, this entire set of files may be routed back to locations specified in contracting party identifiers' DPKI metadata 162a and 162b and deleted from the application server.

In some embodiments, all communications and negotiations relating data model 930a (e.g., the data model parameters), legal prose 910, transaction workflow data, and any legal logic (e.g., the entire hybrid legal contract file 900) may be routed back and forth on a peer-to-peer basis to locations specified in contracting party identifiers' DPKI metadata 162a and 162b.

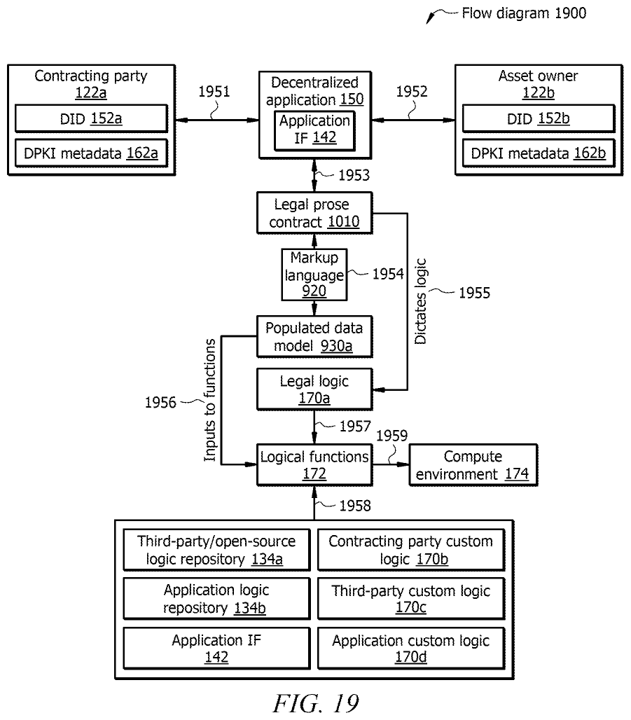

FIG. 19 illustrates a flow diagram 1900 for using legal logic 170a to automate ongoing legal obligations, in accordance with certain embodiments. Flow diagram 1900 includes steps 1951 through 1959.

At step 1951 of flow diagram 1900, contracting party 122a with associated DID 152a and DPKI metadata 162a communicates with application interface 142 to submit a request to transact with asset owner 122b. At step 1952 of flow diagram 1800, decentralized application 150 routes the transaction request to where asset owner 122b (or potential employee) has specified in asset owner's DPKI metadata 162b.

At steps 1953 and 1954 of flow diagram 1900, contracting party 122a and asset owner 122b negotiate legal prose contract 1010 and underlying “deal points” that populate data model 930a using markup language 920. At steps 1955 and 1956 of flow diagram 1900, contracting party 122a and asset owner 122b include legal logic 170a to automate any ongoing legal obligations created by the natural language of legal prose contract 1010. As indicated at step 1955 of flow diagram 1900, legal prose contract 1010 dictates legal logic 170a. As indicated at steps 1956 and 1957 of flow diagram 1900, the executable code that implements legal logic 170a may use the parameters (e.g., variable names 932, data types 934, and/or values 936 described in FIG. 9) in populated data model 930a as inputs to logical functions 172.

As indicated at step 1958 of flow diagram 1900, logical functions 172 that implement legal logic 170a included in the hybrid legal contract file may be obtained from many different sources. For example, contracting party 122a and asset owner 122b may build out their own executable code (e.g., contracting party custom logic 170b) to implement legal logic 170a. As another example, contracting party 122a or asset owner 122b may select standardized code from repositories 134 (e.g., third-party/open-source logic repository 134a or application logic repository 134b) that implement typical legal logic. As still another example, a contracting interface (e.g., application interface 142) may permit “drag and drop” logic building capabilities for users (e.g., lawyers) to build legal logic 170a when negotiating the hybrid legal contract. As yet another example, “legal engineers” may work with lawyers to craft legal logic 170a (e.g., application custom logic 170d). As still another example, third parties may write custom logic (e.g., third-party custom logic 170c) for contracting parties 122 on a consulting basis or build comprehensive logic repositories that can be modified as needed by contracting parties 122. At step 1959 of flow diagram 1900, logical functions 172 are executed in compute environment 174.

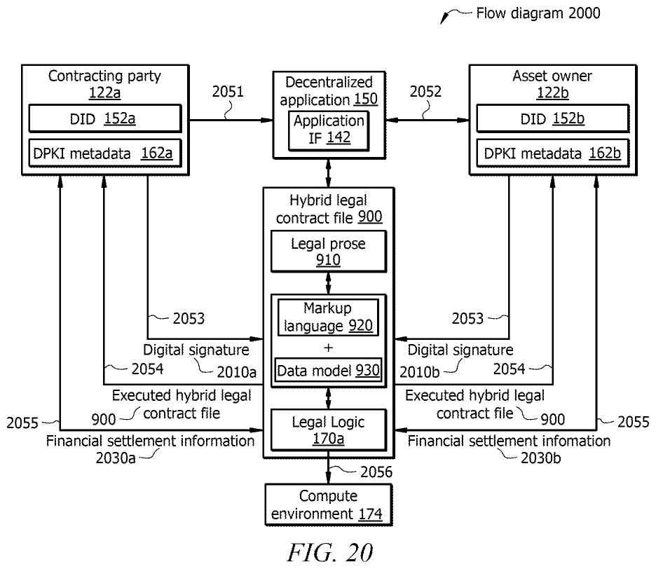

FIG. 20 illustrates a flow diagram 2000 for digitally signing hybrid legal contract file 900, in accordance with certain embodiments. Flow diagram 2000 includes steps 2051 through 2056.

At step 2051 of flow diagram 2000, contracting party 122a with associated DID 152a and DPKI metadata 162a communicates with application interface 142 to submit a request to transact with asset owner 122b. At step 2052 of flow diagram 2000, decentralized application 150 routes the transaction request to where asset owner 122b has specified in asset owner's DPKI metadata 162b. Contracting party 122a and asset owner 122b negotiate legal prose contract 1010 and underlying “deal points” that populate data model 930a using markup language 920.

At steps 2053 of flow diagram 2000, once contracting party 122a and asset owner 122b have agreed to legal prose 910, data model 930 and markup language 920, and/or legal logic 170a, entire hybrid legal contract file 900 is digitally signed by contracting party 122a using digital signature 2010a and asset owner 122b using digital signature 2010b. In certain embodiments, contracting party 122a and asset owner 122b may use one or more methods to digitally sign hybrid legal contract file 900, For example, contracting party 122a and asset owner 122b may use a private key associated with the public key material found in DPKI metadata 162a and 162b of DIDs 152a and 152b, respectively. As another example, contracting party 122a and asset owner 122b may use software such as DocuSign that allows parties to sign contracts and/or other documents electronically. The signature method may be selected based on its ability to cryptographically bind the signatures to DIDs 152a and 152b. In certain embodiments, a service endpoint may be included within DPKI metadata 162a and 162b that links to a particular digital signature method.

In some embodiments, entire hybrid legal contract file 900 is signed with digital signatures 2010a and 2010b associated with DID 152a and DID 152b, respectively, through DPKI metadata 162a and DPKI metadata 162b, respectively. If hybrid legal contract file 900 is hosted on an application server (e.g., application server 140 of FIG. 1), contracting party 122a and asset owner 122b may both sign hybrid legal contract file 900. Hybrid legal contract file 900 may then be routed for storage at a location specified in DPKI metadata 162a and 162b, with hybrid legal contract file 900a then deleted from the application server.

In certain embodiments, updates to hybrid legal contract file 900a are traded on a peer-to-peer basis. Either contracting party 122a or asset owner 122b may digitally sign hybrid legal contract file 900 and then route it peer-to-peer to the other contracting party for digital signature. This process may resemble a multi-signature Bitcoin transaction. Once hybrid legal contract file 900 has both digital signatures 2010a and 2010b, hybrid legal contract file 900 is considered effective, and any changes to hybrid legal contract file 900 later may be tamper-evident based on the underlying digital signature scheme properties. In certain embodiments, decentralized application 150 is given permissioned access to read hybrid legal contract file 900 out of a contracting party's storage to facilitate the digital signature process.

At steps 2054 of flow diagram 2000, executed hybrid legal contract file 900 is communicated to contracting party 122a and asset owner 122b. At steps 2055 of flow diagram 2000, financial settlement information 2030a is communicated to/from contracting party 122a and financial settlement information 2030b is communicated to/from asset owner 122b. If financial settlement is due upon execution of hybrid legal contract file 900, financial settlement may occur as specified in hybrid legal contract file 900, in DPKI metadata 162a, in DPKI metadata 162b, etc. In certain embodiments, financial settlement information 2030a and 2030b may include API calls to payment processors (e.g., Stripe or wire transfer instructions). In some embodiments where financial settlement occurs peer-to-peer through a distributed ledger, financial settlement information 2030a and 2030b may include public key-based payment addresses associated with a given cryptocurrency, stablecoin, central bank digital currency, and the like.

At step 2056 of flow diagram 2000, legal logic 170a is communicated to compute environment 174. In certain embodiments, step 2056 occurs simultaneously with the digital signature process of steps 2053. Once hybrid legal contract file 900 is signed, the source code implementing the logical functions (e.g., logical functions 172 of FIG. 1) may be loaded into compute environment 174 agreed to by the parties. In certain embodiments, this process is documented in hybrid legal contract file 900. In some embodiments, decentralized application 150 performs this process. If contracting party 122a and/or asset owner 122b are uploading legal logic 170a to a distributed ledger, the parties may use a multi-signature distributed ledger transaction to “deposit” legal logic 170a into a location on the distributed ledger (e.g., in a “smart contract”). Depending on the security and privacy requirements of contracting party 122a and/or asset owner 122b, this distributed ledger may be a permissionless distributed ledger (e.g., Ethereum) or a permissioned Distributed Ledger Technology (DLT) instance (e.g., a Hyper ledger Fabric instance). Once on the distributed ledger, legal logic 170a may potentially interact with other legal logic 170 in other “smart contracts” on the same distributed ledger or potentially other distributed ledgers. For example, legal logic 170a may use “call” functions that query other “smart contract” states. In some embodiments, legal logic 170a may be moved into a centralized execution environment (e.g., application server 140 of FIG. 1) as specified by contracting party 122a and/or asset owner 122b.

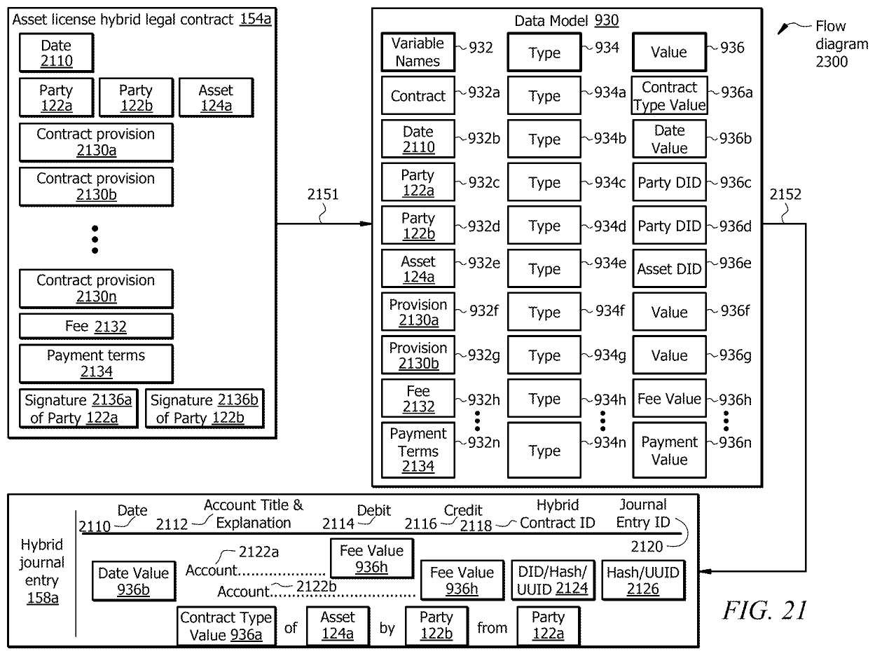

FIG. 21 illustrates a flow diagram 2100 for generating hybrid journal entry 158a, in accordance with certain embodiments. By sharing data model 930 with hybrid legal contract 154a, hybrid journal entry 158a may classify a transaction and maintain consistency with the legal relationship that gives rise to the financial right or obligation that is classified in hybrid journal entry 158a. Similar to hybrid legal contract 154a, hybrid journal entry 158a links to DIDs 152 in shared data model 930. Hybrid journal entries 158 may be generated from historical contracts or newly negotiated contracts. Flow diagram 2100 illustrates the relationship between asset license hybrid legal contract 154a, shared data model 930, and hybrid journal entry 158a that classifies a transaction. Flow diagram 2100 includes steps 2151 through 2152.

At step 2151 of flow diagram 2100, asset license hybrid legal contract 154a is used to populate data model 930. Asset license hybrid legal contract 154a includes a transaction date 2110, party 122a, party 122b, asset 124a, contract provisions 2130a through 2130n (where n represents any suitable integer), a fee 2132, payment terms 2134, signature 2136a of party 122a, and signature 2136b of party 122b.

Data model 930 includes the following parameters: variable names 932, data types 934, and values 936. Variable names 932 include variable names 932a through variable names 932n, where n represents any suitable integer. In the illustrated embodiment of FIG. 21, variable names 932 include a name 932a of asset license hybrid legal contract 154a, a name 932b of transaction date 2110, a name 932c of party 122a to asset license hybrid legal contract 154a, a name 932d of party 122b to asset license hybrid legal contract 154a, a name 932e of asset 124a that is the subject of asset license hybrid legal contract 154a, a name 932f of contract provision 2130a of asset license hybrid legal contract 154a, a name 932g of contract provision 2130b of asset license hybrid legal contract 154a, a name 932h of fee 2132 associated with asset license hybrid legal contract 154a, and so on to a name 932n for payment terms 2134 of asset license hybrid legal contract 154a.

Data types 934 include data type 934a through data type 934n, where n represents any suitable integer. Data types 934 represent the types of data affiliated with each variable name 932, as described in FIG. 9. Values 936 include value 936a through value 936n, where n represents any suitable integer. Values 936 represent the actual values displayed in the legal prose in place of variable names, as described in FIG. 9. Values 936 include contract type value 936a, value 936b of date 2110, party 122a DID as value 936c, party 122b DID as value 936d, asset 124a DID as value 936e, value 936h for fee 2132 (e.g., the transaction amount), and so on to payment value 936n.

In certain embodiments, the application interface (e.g., application interface 142 of FIG. 1) obtains values 936 to populate hybrid journal entry 158a. For example, the application interface may obtain values 936 through a permissions interface associated with a user's data store. As another example, if asset license hybrid legal contract file 900 is being stored on an application server (e.g., application server 140 of FIG. 1) controlled by the decentralized application (e.g., decentralized application 150 of FIG. 1) during the negotiation and execution process, the application interface may obtain values 936 directly from data model 930 of asset license hybrid legal contract 154a.

The various components that make up hybrid journal entry 158a may be obtained directly from data model 930, through a combination of data model 930 and certain database matching functions and/or machine learning algorithms, and the like. For example, value 936b representing transaction date 2110 may be obtained directly from data model 930. As another example, account name 2122a and account name 2122b for account title and explanation entry 2112 of hybrid journal entry 158a may be derived from a function taking the parameters in data model 930 and the contracting party's chart of accounts. As still another example, fee values 936h representing fee 2132 for debit entry 2114 and credit entry 2116 of hybrid journal entry 158a may be obtained directly from data model 930.

As another example, the short description of the transaction classified by hybrid journal entry 158a (“contract type value 936a” of “asset 124a” by “party 122b” from “party 122a”) may be derived from a function taking values 936 in data model 930 and a natural language processing (or similar) algorithm. As still another example, hybrid legal contract identifier 2118 (DID/Hash/UUID 2124) may be obtained directly from data model 930 or a DID generation function taking as input hybrid legal contract 154a. The hybrid legal contract identifier may be a DID for the hybrid legal contract, simple hash values of the hybrid legal contract file, “smart contract” addresses residing on a distributed ledger, and the like.

As another example, journal entry identifier 2120 may be derived from hybrid journal entry 158a itself. Journal entry identifier 2120 helps identify hybrid journal entry 158a later when values 936 are posted to the hybrid general ledger (e.g., hybrid general ledger 156 of FIG. 1). Journal entry identifier 2120 may be derived by hashing populated hybrid journal entry 158a and using the hash value as an identifier and cryptographic digest.

In certain embodiments, hybrid journal entry 158a is stored at a location on a network as set forth in the contracting party identifiers' DPKI metadata so that the legal, financial, and accounting aspects of a single transaction can be stored together.

The same process may be used to generate the hybrid journal entry (e.g., hybrid journal entry 158b of FIG. 1) for another contracting party from shared data model 930. The accounts for the hybrid journal entry of the other contracting party may be impacted, and the short description of the transaction will be different based on the chart of accounts of the other contracting party and/or the fact that the hybrid journal entry for the other contracting party is recognizing a different accounting “event” from the same transaction.

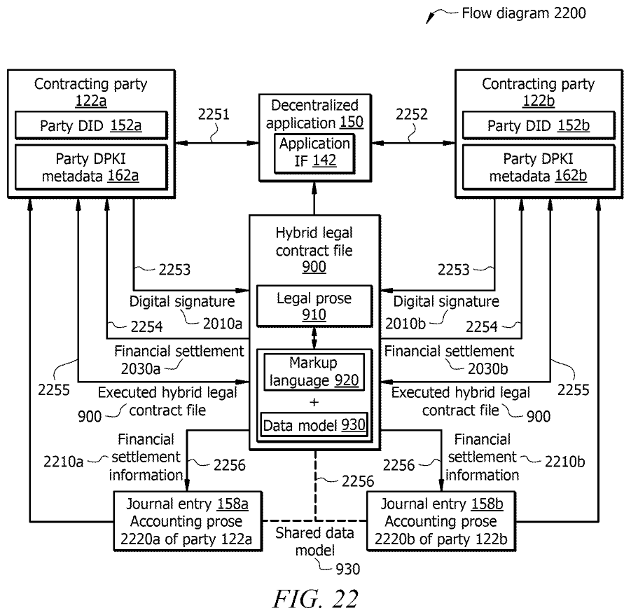

FIG. 22 illustrates a flow diagram 2200 for generating hybrid journal entries 158a and 158b for contracting parties 122a and 122b, respectively, in accordance with certain embodiments. Flow diagram 2200 includes steps 2251 through 2256.

At steps 2251 and 2252 of flow diagram 2200, contracting party 122a associated with DID 152a and DPKI metadata 162a and contracting party 122b associated with DID 152b and DPKI metadata 162b communicate with application interface 142 to transact with each other.

At steps 2253 of flow diagram 2200, once contracting parties 122a and 122b have agreed to legal prose 910, data model 930, and markup language 920, hybrid legal contract file 900 is digitally signed by contracting party 122a (see digital signature 2010a) and contracting party 122b (see digital signature 2010b).

At steps 2254 of flow diagram 2000, financial settlement information 2030a is communicated to contracting party 122a, and financial settlement information 2030b is communicated to contracting party 122b. At steps 2255 of flow diagram 2000, executed hybrid legal contract file 900 is communicated to contracting parties 122a and 122b.

At steps 2256 of flow diagram 2000, financial settlement information 2210a is communicated to hybrid journal entry 158a, and financial settlement information 2210b is communicated to hybrid journal entry 158b. In certain embodiments, hybrid journal entries 158a and 158b are generated (e.g., populated) using financial settlement information 2210a and 2210b, respectively, as described in FIG. 21. Once hybrid journal entries 158a and 158b are stored in locations set forth in parties' DPKI metadata 162a and 162b, the data may be manipulated to build out the other aspects of any traditional accounting system, such as a hybrid general ledger, trial balances, financial statements, etc.

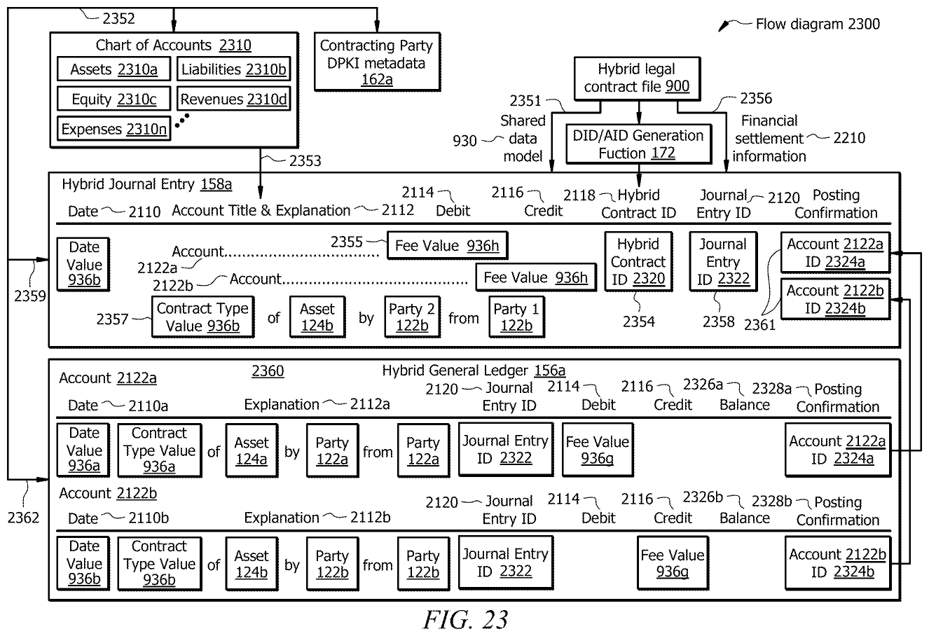

FIG. 23 illustrates a flow diagram 2300 for populating hybrid journal entry 158a and posting hybrid journal entry 158a to hybrid general ledger 156a, in accordance with certain embodiments. Flow diagram 2300 includes steps 2351 through 2362.

At step 2351 of flow diagram 2300, the decentralized application (decentralized application 150 of FIG. 1) uses shared data model 930 of hybrid legal contract file 900 to populate hybrid journal entry 158a. In certain embodiments, the decentralized application populates hybrid journal entries 158 for each counterparty of the transaction.

At steps 2352 and 2353 of flow diagram 2300, the decentralized application classifies the accounts that are impacted from the transaction. In certain embodiments, a contracting party is associated with a chart of accounts 2310. Chart of accounts 2310 includes assets 2110a, liabilities 2310b, equity 2310c, revenues 2310d, and so on to expenses 2310n, where n represents any suitable integer. Chart of accounts 2310 may be stored on an application server (e.g., application server 140 of FIG. 1) controlled by the decentralized application. In some embodiments, the decentralized application is given permission to read the data from chart of accounts 2310 from a location as set forth in DPKI metadata 162a of the contracting party.

In certain embodiments, chart of accounts 2310 is input into a function that takes the parameters from data model 930 and chart of accounts 2310 and classifies accounts 2122 (e.g., account 2122a and account 2122b) based on specific account names and numbers. In the event the contracting party does not have chart of accounts 2310, the decentralized application may provide account names and numbers to the contracting party. In some embodiments, the decentralized application populates each component of hybrid journal entry 158a from values 936 of data model 930, from a combination of information obtained from data model 930 and machine learning algorithms (e.g., natural language processing), and the like.

At step 2354 of flow diagram 2300, hybrid legal contract identifier 2320 is obtained from hybrid legal contract file 900. At step 2355 of flow diagram 2300, fee values 936h are obtained from data model 930. In certain embodiments, fee values 936h only provide amounts and not information relating to actual financial settlement. At step 2356 of flow diagram 2300, financial settlement information 2210 is received from hybrid legal contract file 900. If financial settlement occurs through traditional payment methods, financial settlement information 2210 may be obtained from various payment APIs and included within hybrid journal entry 158a. If financial settlement occurs using a blockchain or distributed ledger, financial settlement information 2210 from the blockchain transaction (e.g., block number, transaction ID, transaction hash, public-key based accounts of the payor and payee, etc.) may be stored within hybrid journal entry 158a.

At step 2357 of flow diagram 2300, a short description of the transaction is generated by the decentralized application. For example, the short description of the transaction may be generated through data model 930, a combination of data model 930 and a function (or functions) that output a natural language prose classification, and the like. In certain embodiments, this natural language description uses the same framework as hybrid legal contract file 900 to tie the natural language prose to data model parameters through a markup language. This allows the DIDs of the contracting parties and any assets to be integrated into hybrid journal entry 158a.

At step 2358 of flow diagram 2300, once hybrid journal entry 158a is populated, the decentralized application provides hybrid journal entry 158a with a unique identifier 2322 as part of the process of “posting” hybrid journal entry 158a to hybrid general ledger 156a. If the file of hybrid journal entry 158a is hashed using a hash function, this provides a unique identifier as well as cryptographic assurance that hybrid journal entry 158a has not been modified later.

At step 2359 of flow diagram 2300, the decentralized application routes hybrid journal entry 158a for storage at a location set forth in contracting party's DPKI metadata 162a. In certain embodiments, hybrid journal entry 158a is stored with hybrid legal contract file 900 and the transaction workflow data so that all legal, financial, and accounting information for a specific transaction are stored together.

At step 2360 of flow diagram 2300, the decentralized application posts (or provides functionality for the contracting party to post) hybrid journal entry 158a to applicable accounts 2122a and 2122b in hybrid general ledger 156a. In certain embodiments, the decentralized application obtains values 936 from shared data model 930a and/or the components of hybrid journal entry 158a.

At step 2361 of flow diagram 2300, once the posting process is complete, the decentralized application creates confirmation identifiers 2324a and 2324b that can be stored in the file of hybrid journal entry 158a. In certain embodiments, confirmation identifiers 2324a and 2324b are cryptographic hashes of accounts 2122a and 2122b, respectively. Confirmation identifiers 2324a and 2324b may be generated immediately after the components of hybrid journal entry 158a are posted to hybrid general ledger 156a, which provides both a unique identifier and cryptographic assurance that accounts 2122a and 2122b of hybrid general ledger 156a immediately after posting have not been modified later. At step 2362 of flow diagram 2300, the decentralized application routes the file of hybrid general ledger 156a for storage at a location set forth in contracting party's DPKI metadata 162a.

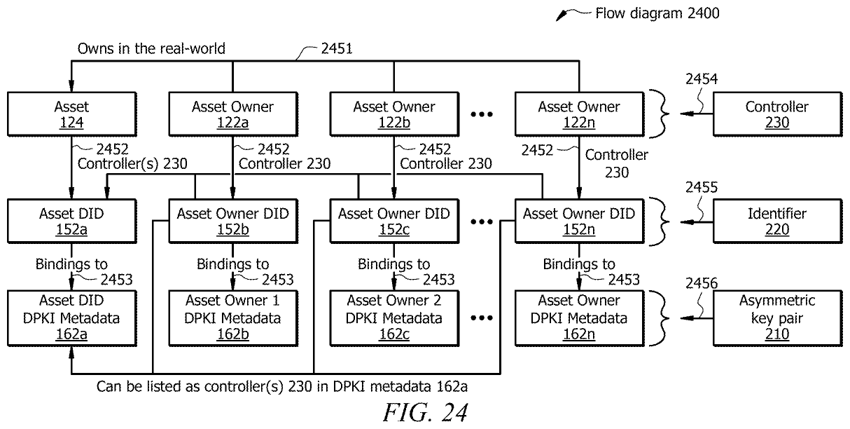

FIG. 24 illustrates a diagram 2400 for establishing ownership of asset 124 using DIDs, in accordance with certain embodiments. Ownership and authority over asset 124 in the “real world” may be based on a legal framework, such as constitutions, statutes, contracts, and judicial systems. Ownership and authority over a digital representation of asset 124 may depend on software and/or cryptography. Through DIDs 152a through 152n, consistency of ownership and/or authority over asset 124 may be maintained with ownership and/or authority over the digital representation of asset 124. In certain embodiments, changes in ownership of and/or authority over both the “real world” asset (e.g., a copyright) and its digital representation (in terms of an identity of the copyright) are automated using hybrid legal contracts. Diagram 2400 includes notations 2451 through 2456.

Notation 2451 of diagram 2400 illustrates asset 124 being owned by asset owners 122a, 122b, and so on to 122n (where n represents any suitable integer) in the “real world,” where asset 124 and asset owners 122a through 122n have legal names. Notation 2452 of diagram 2400 illustrates the relationship between asset 124 and asset owners 122a, 122b, and so on to 122n in the “digital world,” where asset 124 and asset owners 122a through 122n have DIDs 152. In diagram 2400, asset 124 is associated with DID 152a, asset owner 122a is associated with DID 152b, asset owner 122b is associated with DID 152c, and so on to asset owner 122n associated with DID 152n.

Notations 2453 of diagram 2400 illustrate representations of digital characteristics and facilitating digital interactions. Asset DID 152a and asset owner DIDs 152b through 152n have DPKI metadata (e.g., DID documents for DIDs 152 or key event logs for AIDs) that is bound to DIDs 152 through a verifiable data registry (e.g., verifiable data registries 136 of FIG. 1). In diagram 2400, asset DID 152a has bindings to asset DPKI metadata 162a, asset owner DID 152b has bindings to asset owner DPKI metadata 162b, asset owner DID 152c has bindings to asset owner DPKI metadata 162c, and so on to asset owner DID 152n, which has bindings to asset owner DPKI metadata 162n.

In certain embodiments, the bindings of an identity system are used to tie asset 124 to asset owners 122a through 122n in the digital world. Notation 2454 of diagram 2400 illustrates how asset owner 122a controls asset owner DID 152b, asset owner 122b controls asset owner DID 152c, and asset owner 122c controls asset owner DID 152d.

Notation 2455 of diagram 2400 illustrates how asset owner DIDs 152b, 152c, and/or 152d may control asset DID 152a. For example, asset owner DIDs 152b, 152c, and/or 152d may be listed as controllers 230 of asset DID 152a in asset's DPKI metadata 162a.

Notation 2456 of diagram 2400 illustrates the relationship between the authentication factors (e.g., asymmetric key pair 210) and DPKI metadata 162a, 162b, 162c, and so on to 162n affiliated with DIDs 152, 152b, 152c, and so on to 152n, respectively. In the DID framework, this is the DID document. In the KERI framework, this is the key event log. In certain embodiments, asset owner DIDs 152a through 152n are listed as controllers 230 in asset DID's DPKI metadata 162 (or this can be withheld or obfuscated for privacy reasons).

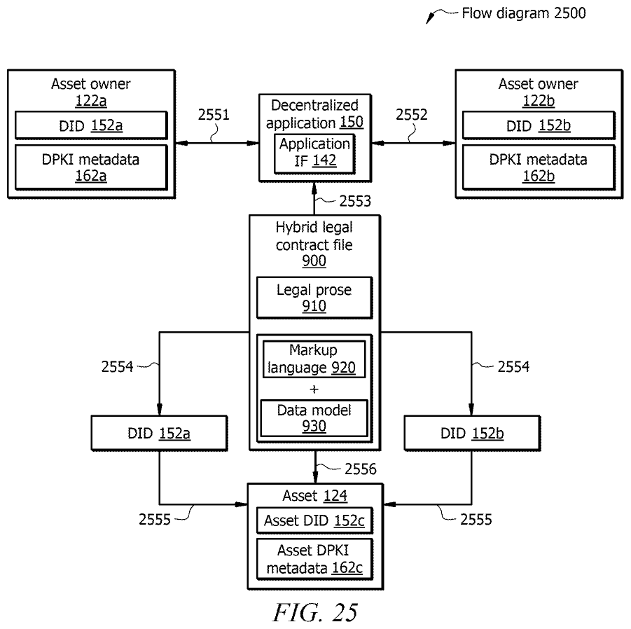

FIG. 25 illustrates a flow diagram 2500 for populating the controller property of asset DID 152c in asset DPKI metadata 162c using hybrid legal contract 154a, in accordance with certain embodiments. Flow diagram 2500 includes steps 2551 through 2556. At steps 2551 through 2553 of flow diagram 2500, contracting party 122a with associated DID 152a and DPKI metadata 162a and contracting party 122b with associated DID 152b and DPKI metadata 162b communicate with application interface 142 to generate hybrid legal contract file 900 that determines ownership of asset 124. At steps 2554 through 2556 of flow diagram 2500, data model 930 of hybrid legal contract file 900 is used to populate the controller property of asset DPKI metadata 162c with DID 152a and DID 152b.

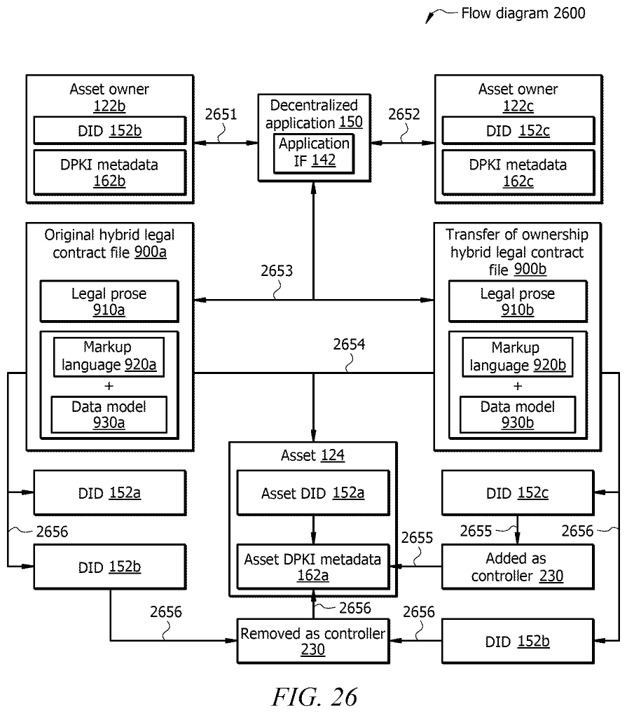

FIG. 26 illustrates a flow diagram 2600 for documenting a transfer of ownership interest in asset 124, in accordance with certain embodiments. Flow diagram 2600 includes steps 2651 through 2656. At steps 2651 through 2653 of flow diagram 2600, asset owner 122b sells its ownership interest in asset 124 to asset owner 122c and documents the transfer of ownership in hybrid legal contract file 900b. The ownership interest of asset owner 122b in asset 124 is documented in original hybrid contract file 900a, and an identifier for original hybrid contract file 900a can be included in data model 930b of hybrid legal contract file 900b to maintain a chain of title. At step 2654 of flow diagram 2600, asset 124 is associated with asset DID 152a and asset DPKI metadata 162a. At step 2655 of flow diagram 2600, upon execution of transfer of ownership in hybrid legal contract 900b, DID 152c associated with asset owner 122c is added as controller 230 of asset DID 152a in asset DPKI metadata 162a. At step 2656 of flow diagram 2600, asset owner 122b is removed as controller 230 within asset DPKI metadata 162b.

FIG. 27 illustrates a flow diagram 2700 for encapsulating legal contract provisions of hybrid legal contract file 900 within a verifiable credential 2714, in accordance with certain embodiments. The framework described in FIG. 26 for setting the controller property in asset identifier's DPKI metadata 162a does not specify certain ownership qualities (e.g., a percentage of asset 124a owned) or administration privileges without actual ownership. Verifiable credential 2714 may be issued for ownership, authorization, and/or administrative information attesting to the provisions of data model 930a of hybrid legal contract file 900a relating to ownership, authorization, and/or administration capabilities (e.g., privileges). Flow diagram 2700 includes steps 2751 through 2755.

At step 2751 of flow diagram 2700, the parameters of hybrid legal contract file 900 are populated in data model 930. The parameters of data model 930 include variable names 932, data types 934, and values 936. At step 2752 of flow diagram 2700, data value 936a representing asset DID 152c is resolved to obtain asset DPKI metadata 162a. At step 2753 of flow diagram 2700, data value 936b representing party DID 152a and data value 936c representing party DID 152b are listed as controllers in asset DPKI metadata 162a.

At step 2754 of flow diagram 2700, the decentralized application generates a credential graph 2710. Credential graph 2710 is a network of information composed of credential subject 2720 and its relationship to other data. Credential graph 2710 includes a credential type 2712 for ownership, verifiable credential 2714, an issuance date 2716, a claim 2718, a credential subject 2720, and an issuer 2722.

In certain embodiments, verifiable credential 2714 may be issued by one or both contracting parties to hybrid legal contract file 900. In some embodiments, verifiable credential 2714 may be issued by a third party such as the decentralized application or a government authority. Verifiable credential 2714 may be issued directly to asset DID 152c to be held within asset DID's DPKI metadata, within a digital wallet or data store associated with asset DID 152c, and the like. In flow diagram 2700, asset DID 152c represents both credential subject 2720 and the holder of verifiable credential 2714. In certain embodiments, verifiable credential 2714 is issued to one or both of the contracting parties such that asset DID 152c is credential subject 2720 and contracting party DIDs 152a and 152b are the holders of verifiable credential 2714. In certain embodiments, claim 2718 defines the capabilities relating to the subject of the transaction. The capabilities may include ownership capabilities, administration capabilities, authorization capabilities, and the like. In the illustrated embodiment of FIG. 27, claim 2718 defines the capabilities relating to ownership.

At step 2755 of flow diagram 2700, the decentralized application generates a credential proof graph 2730. Credential proof graph 2730 expresses the proof of credential graph 2710. Credential proof graph 2730 includes a signature 2732, a nonce 2734, a signature value 2736, a signature type 2738 (e.g., a Rivest-Shamir-Adleman (RSA) signature), a creation date 2740, and a creator 2742 (e.g., application public key 320a).

Credential proof graph 2730 utilizes application public key 320a and digital signature 2732 from issuer 2722, which in this case is decentralized application 150. Credential proof graph 2730 is used to cryptographically verify claims 2718 in verifiable credential 2714. As illustrated in credential graph 2710, contracting parties 122a and 122b each own 50 percent of asset 124. As illustrated by data value 936d in data model 930, asset identifier's controller property in its DPKI metadata 162c is populated with contracting party DIDs 152a and 152b in data model 930. Verifiable credential 2714 represents the specific ownership interests of contracting party DIDs 152a and 152b in asset 124 (e.g., 50% each). Credential graph 2710 and credential proof graph 2730 may be represented in JavaScript Object Notation (JSON), JSON for Linked Data (JSON-LD), or any other suitable format.

FIG. 28 illustrates a flow diagram 2800 for issuing a verifiable credential 2714 based on legal provisions in a hybrid legal contract, in accordance with certain embodiments. Flow diagram 2800 includes steps 2851 through 2858.

At steps 2851 through 2853 of flow diagram 2800, contracting party 122a with associated DID 152a and DPKI metadata 162a and contracting party 122b with associated DID 152b and DPKI metadata 162b communicate with application interface 142 to generate hybrid legal contract file 900.

At steps 2854 through 2856 of flow diagram 2800, hybrid legal contract file 900 is assigned its own hybrid contract DID 152c, which allows hybrid legal contract file 900 to send and/or receive verifiable credential 2714. Verifiable credential 2714 may include the contents of data model 930 of hybrid legal contract file 900. Hybrid contract DID 152c and its associated DPKI metadata 162c can then be controlled by contracting party DIDs 152a and 152b, who can set the policy of hybrid legal contract file 900 for responding to queries or making statements of its own.

At step 2857 of flow diagram 2800, decentralized application 150 generates credential graph 2710. Credential graph 2710 includes credential type 2712, verifiable credential 2714, issuance date 2716, claim 2718, credential subject 2720, issuer 2722, contract DID 152c, contracting party 122b, contract provision 2130a, and contract provision 2130b. In credential graph 2710, issuer 2722 is the hybrid legal contract identifier (e.g., contract DID 152c). Credential graph 2710 utilizes the provisions of data model 930.

Verifiable credential 2714 is issued for contract provisions 2730a and 2730b within hybrid legal contract file 900a. Verifiable credential 2714 is not limited to ownership. Any value (e.g., values 936 of FIG. 27) within data model 930 of hybrid legal contract file 900 may be mapped to the schema of verifiable credential 2714. For example, verifiable credential 2714 may represent the term of the hybrid legal contract, a specific authority for contracting party 122a or 122b (such as a copyright licensee), termination criteria such that termination of the hybrid legal contract invokes a revocation of verifiable credential 2714, and the like.

As illustrated in flow diagram 2800, hybrid legal contract file 900 receives its own hybrid contract DID 152c and issues verifiable credential 2714 using contract provisions from data model 930 as claims 2718. Hybrid contact DID 152c is issuer 2722 of verifiable credential 2714 and contracting party 122b is credential subject 2720. In certain embodiments, verifiable credential 2714 may be issued to contracting party 122b as both credential subject 2720 and credential holder. In some embodiments, verifiable credential 2714 is issued to a third party to be the holder.

At step 2858 of flow diagram 2800, decentralized application 150 generates credential proof graph 2730. Credential proof graph 2730 includes signature 2732, nonce 2734, signature value 2736, signature type 2738 (e.g., an RSA signature), creation date 2740, and creator 2742 (e.g., contract DID public key 320a). Public key material in hybrid contract DPKI metadata 162c is used to cryptographically sign credential proof graph 2730.

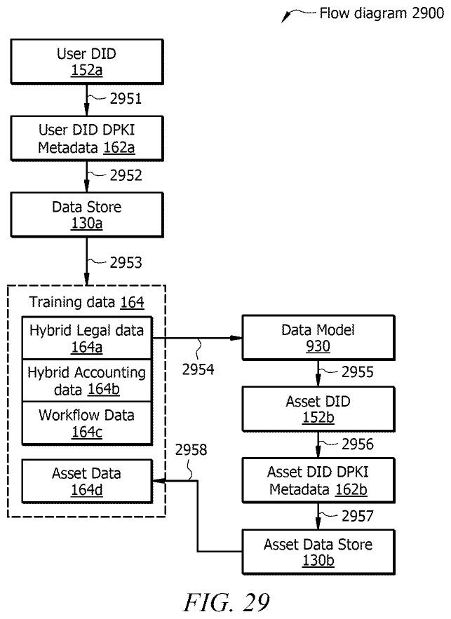

FIG. 29 illustrates a flow diagram 2900 for aggregating data sets to train machine learning models, in accordance with certain embodiments. In the illustrated embodiment of FIG. 29, data is aggregated from user data store 130a and asset data store 130b. Flow diagram 2900 includes steps 2951 through 2958.

At steps 2951 and 2952 of flow diagram 2900, user DID DPKI metadata 162a associated with user DID 152a has information relating to the location of user data store 130a. Every aspect of the contractual environment for a given transaction may be aggregated in a single location, such as user data store 130a as dictated by the contracting parties.

At step 2953 of flow diagram 2900, the decentralized application (e.g., decentralized application 150 of FIG. 1) accesses training data 164 from user data store 130a. Training machine learning models on centrally aggregated datasets is possible through the permissions interface of the storage mechanism designated by the contracting party identifiers' DPKI metadata, such as through an identity hub. In flow diagram 2900, the decentralized application is given permissioned access to obtain specific training data 164 located in user data store 130a. At steps 2954 through 2958 of flow diagram 2900, additional training data 164 related to asset 124 is obtained from asset data store 130b that is controlled by user DID 152a as controller of asset DID 152b.

In certain embodiments, training data 164 is aggregated on the application server (e.g., application server 140 of FIG. 1) where the machine learning models are trained. In certain embodiments, after training is complete, the trained models are made available to the application interface (e.g., application interface 142 of FIG. 1), and training data 164 is deleted from the application server. Machine learning techniques are applied to training data 164 to look for insights across the aggregated datasets. Training data 164 may include hybrid legal data 164a, hybrid accounting data 164b, workflow data 164c, asset data 164d, etc.

Hybrid legal data 164a represents information relating to the hybrid legal contract (e.g., hybrid legal contract 154 of FIG. 1), such as the parameters of data model 930. Hybrid accounting data 164b represents accounting information relating to the hybrid legal contract. Hybrid accounting data 164b may include data associated with hybrid journal entries (e.g., hybrid journal entries 158 of FIG. 1), hybrid general ledgers (e.g., hybrid general ledgers 156 of FIG. 1), financial data (e.g., financial data 166 of FIG. 1), financial statements, and the like.

Workflow data 164c represents transaction workflow data. In certain embodiments, workflow data 164 includes communications of the contracting parties through the application interface (e.g., application interface 142 of FIG. 1). The communications may be obtained through a peer-to-peer messaging protocol facilitated by the decentralized application where the conversations are transferred to data stores after they occur. In some embodiments, the communications may be obtained from an email-type system where messages are routed directly into data stores. Workflow data 164c may be used to train reinforcement learning-based chatbots or other natural language processing (NLP) applications for personalized predictive text, etc. Other communication forms (e.g., traditional email) may be added by the user through the application interface.

In certain embodiments, workflow data 164 includes the changes in the back-and-forth negotiating process of the hybrid legal contract. For example, workflow data 164 may include aspects of the redlining process by attorneys. Workflow data 164 may be used for supervised learning (e.g., to predict how parties will react to different negotiating tactics), reinforcement learning (e.g., with a naïve implementation the reward function is the potential fee for the hybrid legal contract, where one contracting party's agent seeks to maximize this reward function (e.g., the fee) and the other contracting party's agent seeks to minimize the reward function (e.g., the fee), and the “environment” is the contracting environment itself with “actions” being the changes to the legal parameters in data model 930 or natural language prose), and the like. Asset data 164d represents information about an asset that is the subject of the hybrid legal contract.

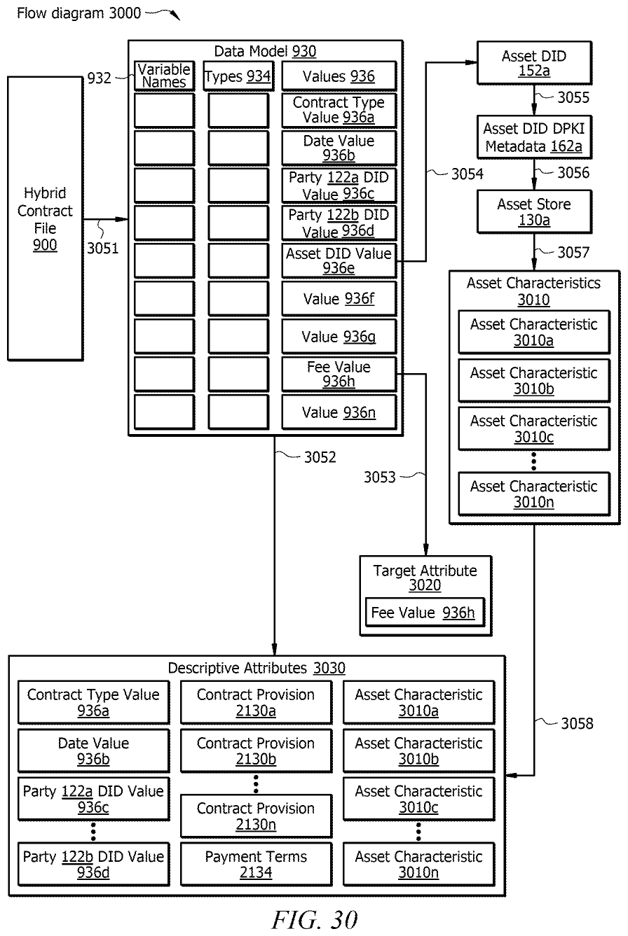

FIG. 30 illustrates a flow diagram 3000 for applying machine learning techniques to aggregated data sets, in accordance with certain embodiments. Flow diagram 3000, which applies a supervised learning technique, includes steps 3051 through 3054.

At step 3051 of flow diagram 3000, provisions of hybrid legal contract file 900 are integrated in data model 930. The provisions of data model 930 include variable names 932, data types 934, and values 936. At step 3052 of flow diagram 3000, the parameters that make up data model 930 are identified as descriptive attributes 3030. Descriptive attributes 3030 include contract type value 936a, date value 936b, party 122a DID value 936c, party 122b DID value 936d, contract provisions 2130a through 2130n (where n represents any suitable integer), and payments terms 2134.

At step 3053 of flow diagram 3000, the financial component (fee value 936h) of hybrid legal contract file 900 is identified as target attribute 3020. Target attribute 3020 in training data 164 represents the output of a model that the descriptive attribute inputs are mapped to. Target attribute 3020 may be categorical, continuous, etc. In certain embodiments, target attribute 3020 is mapped to descriptive attributes 3030 through classification, regression, and the like.

At steps 3054 through 3056 of flow diagram 3000, additional descriptive attributes 3030 are included by obtaining data from asset DID 152a that is the subject of hybrid legal contract file 900. At steps 3055 and 3056 of flow diagram 3000, the location of asset data store 130a can be resolved from asset DID DPKI metadata 162a that is associated with asset DID 152a.

At step 3057 of flow diagram 3000, asset characteristics 3010 (e.g., asset characteristics 3010a through 3010n, where n represents any suitable integer) are obtained from data store 130a. At step 3058 of flow diagram 3000, asset characteristics 3010a through 3010n are included in descriptive attributes 3030 by a party DID as controller of asset DID 152a. in certain embodiments, asset characteristics 3010 are included in descriptive attributes 3030 by the decentralized application. Combined descriptive attributes 3030 may be used for more accurate pattern recognition between legal parameters, asset characteristics 3010, and target attribute 3020 (such as the financial payment). Descriptive attributes 3030 and target attribute 3020 constitute training data 164 (e.g., hybrid legal data 164a and asset data 164d) as shown in FIG. 29.

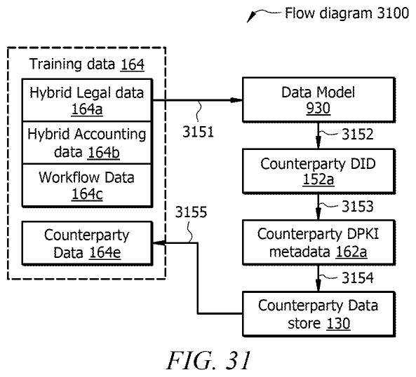

FIG. 31 illustrates a flow diagram 3100 for aggregating data sets to train machine learning models, in accordance with certain embodiments. In the illustrated embodiment of FIG. 31, training data 164 is aggregated from hybrid legal data 164a, hybrid accounting data 164b, workflow data 164c, and counterparty data 164e located in counterparty data store 130a. Flow diagram 3100 includes steps 3151 through 3155.

At step 3151 of flow diagram 3100, the decentralized application (e.g., decentralized application 150 of FIG. 1) accesses data model 930 of the hybrid legal contract (e.g., hybrid legal contract 154 of FIG. 1). At step 3152 of flow diagram 3100, counterparty DID 152a is obtained from shared data model 930. At step 3153 of flow diagram 3100, counterparty DID 152a is associated with counterparty DPKI metadata 162a. At step 3154 of flow diagram 3100, the location of counterparty data store 130a is resolved from counterparty DPKI metadata 162a. At step 3155 of flow diagram 3100, the decentralized application accesses counterparty data 164e from counterparty data store 130. For example, the decentralized application may be granted permission to access and obtain specific data in counterparty data store 130 associated with the counterparty. In the illustrated embodiment of FIG. 31, training data 164 includes hybrid legal data 164a, hybrid accounting data 164b, workflow data 164c, and counterparty data 164e. In certain embodiments, counterparty data 164e represents publicly available information about the counterparty to a transaction. Counterparty data 164e may be aggregated so that patterns can be found within legal, financial, accounting, and counterparty training data 164.

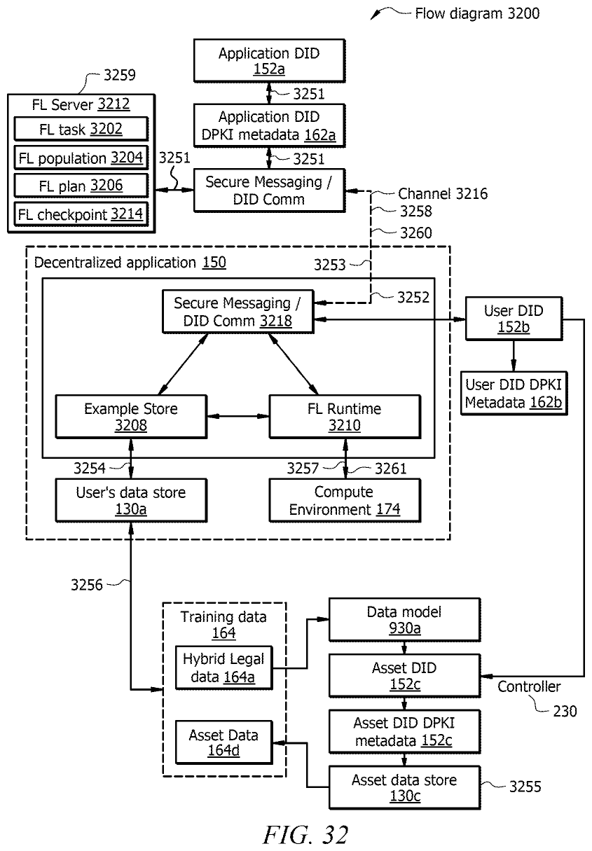

FIG. 32 illustrates a flow diagram 3200 for performing federated learning on datasets through a decentralized identity system, in accordance with certain embodiments. Flow diagram 3200 includes a federated learning (FL) task 3202, an FL population 3204, an FL plan 3206, an example store 3208, an FL runtime 3210, an FL server 3212, and an FL checkpoint 3214. FL task 3202 represents a specific computation for FL population 3204. For example, FL task 3202 may include training to be performed with given hyperparameters or evaluation of trained models on client-side data, a specific FL plan 3206 to be executed, and the like. FL population 3204 represents a subset of clients that participate in federated learning by executing FL task 3202.

FL plan 3206 represents a data structure that may include model architecture and/or instructions on how to execute the model. For TensorFlow or PyTorch neural network architectures, FL plan 3206 may include a TensorFlow or PyTorch graph. In certain embodiments, FL plan 3206 includes two parts 3206a and 3206b. FL plan 3206a is for the local client (e.g., decentralized application 150), which may include the model itself, selection criteria for data held client-side (e.g., in a data store), hyperparameters and/or instructions on how to batch data and/or route the data through example store 3208 (e.g., a data handler, etc.). FL plan 3206b is for FL server 3212, which may include the aggregation function. Example store 3208 is an abstraction of a function to access and/or preprocess training data held client-side. In certain embodiments, the training data is stored in a data store.

FL runtime 3210 (e.g., a local training handler) represents an abstraction of a function to perform training of a model within a compute environment on client-side data. In certain embodiments, the client-side data is obtained through example store 3208 (e.g., a data handler). FL Server 3212 represents the server providing a coordination and/or aggregation function for the federated learning process. FL checkpoint 3214 represents the serialized state of a model that can be sent over a communication network (e.g., a TensorFlow or PyTorch session). In certain embodiments, the model includes the current global model parameters, information relating to “counts” for calculating information gain for decision trees, etc. Flow diagram 3200 includes steps 3251 through 3261.

In flow diagram 3200, all users have DIDs with associated DPKI metadata. At steps 3251 of flow diagram 3200, FL server 3212 (which in flow diagram 3200 is operated by decentralized application 150) is associated with application DID 152a and application DID DPKI metadata 162a.

User DID 152b and application DID 152a for FL server 3212 establish a secure bidirectional communication channel 3216 using the public-private key material and service endpoints in their respective DPKI Metadata 162. In certain embodiments, the transport medium is specified in the service endpoints (e.g., Hypertext Transfer Protocol Secure (HTTPS), WebSockets, gRPC, etc.). All messages and communications between the users and FL server 3212 may be end-to-end encrypted. This framework/protocol has been simplified in the diagram with an abstraction 3218 called Secure Messaging/DID Comm. Communication channel 3216 is represented in FIG. 32 by a dashed line.

At step 3252 of flow diagram 3200, once communication channel 3216 is created, decentralized application 150 and FL runtime 3210 configure example store 3208 (e.g., a data handler, etc.) to determine what data is available for training in user's data store 130. For example, example store 3208 may determine which FL populations 3204 this user's data are a part of and inform the FL server 3212. In certain embodiments, FL server 3212 prepares FL task 3202 for a given FL population 3204 and queries the users for availability for training. The users respond if certain training conditions are met, such as available compute resources.

At step 3253 of flow diagram 3200, FL server 3212 selects users for given FL task 3202 and sends FL plan 3206 for FL task 3202 to decentralized application 150. Decentralized application 150 may be a desktop-based implementation, a web-based application, etc. In certain embodiments, FL plan 3206 includes the model architecture, hyperparameters, data needed to be obtained from various data stores, instructions for executing training, etc. The aggregation function performed by FL server 3212 (e.g., federated averaging, secure aggregation, etc.) may be specified as part of FL plan 3206. At step 3254 of flow diagram 3200, FL runtime 3210 obtains the required data from the users' data store 130a through example store 3208.

At step 3255 of flow diagram 3200, asset data store 130c allows the DIDs or AIDs that are listed as controllers in asset DID DPKI metadata 162c to read/write any data in asset data store 130c. In certain embodiments, FL server 3212 handles obtaining the data from both user's data store 130a and asset's data store 130c and moving it through the example store 3208 (e.g., data handler) and into FL runtime 3210 for model training. In this case, FL server 3212 obtains the required permissions in the various data store permissions interfaces.

At step 3256 of flow diagram 3200, FL plan 3206 includes instructions on combining training data 164 from hybrid legal contracts, hybrid journal entries, workflow data, etc. held in user data store 130a with asset-related data from asset data store 130c. At step 3257 of flow diagram 3200, FL runtime 3210 (e.g., a local training handler) performs any required pre-processing and moves this aggregated training dataset into compute environment 174 for model training. At step 3258 of flow diagram 3200, after one round of training, model updates are retrieved from compute environment 174 by FL runtime 3210 and sent back to FL server 3212.

At step 3259 of flow diagram 3200, an aggregation function is performed on the model updates received by FL server 3212. The aggregation function may include “federated averaging,” a form of “secure aggregation” with various multi-party or functional encryption techniques, and the like. Once the updated model is available, FL server 2312 checks for termination criteria (e.g., a predetermined number of training runs, a predetermined accuracy on held-out data, other metrics, etc.). In certain embodiments, FL server 2312 evaluates the model on proxy data. In some embodiments, FL server 2312 may send the model back to the users to be evaluated. The users may evaluate the model based on a held-out test set as specified by FL plan 3206 and/or example store 3208.

At step 3260 of flow diagram 3200, if termination criteria are satisfied, the trained global model is communicated back to (or otherwise made available to) decentralized application 150. Decentralized application 150 may evaluate the trained global model on held-out data, allow the user to use the trained model in production, etc. If the termination criteria are not satisfied, FL server 2312 repeats the process by sending the updated model parameters as FL checkpoint 3214, and training may start again based on the instructions in FL plan 3206.

At step 3261 of flow diagram 3200, after training is completed, training data 164 is deleted from compute environment 174 and all temporary resources are cleaned up. During training, all metadata about the training process may be logged and sent back to FL server 3212 for calculating various metrics. In certain embodiments, this metadata (e.g., training logs, timestamps, which DIDs accessed data in the data store, etc.) is written to user data store 130a for record keeping purposes.

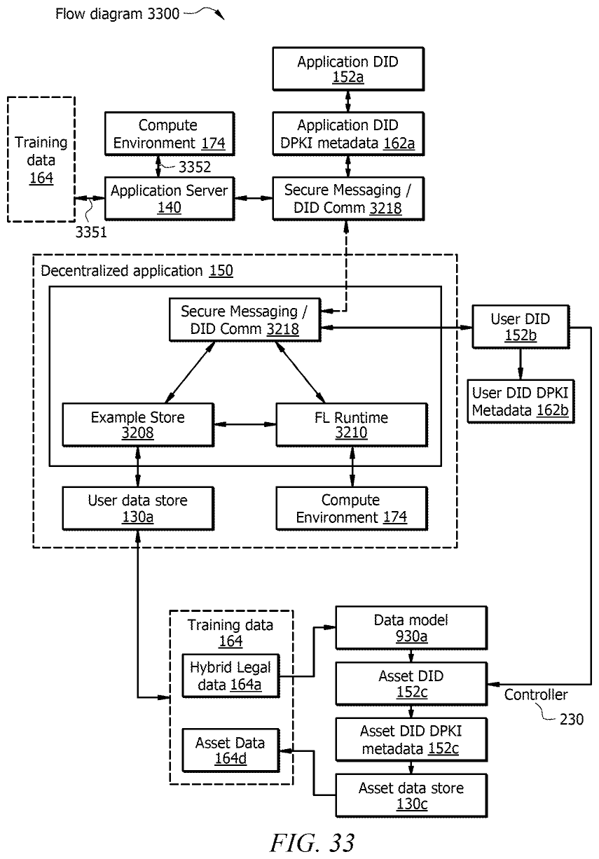

FIG. 33 illustrates a flow diagram 3300 for training machine learning models on centrally aggregated datasets, in accordance with certain embodiments. Training machine learning models on centrally aggregated datasets is possible through the permissions interface of the storage mechanism designated by the contracting party identifiers' DPKI metadata. With centralized model training, decentralized application 150 is given permissioned access to obtain specific data in data stores 130 associated with contracting parties and assets that use the application interface (e.g., application interface 142 of FIG. 1).

Flow diagram 3300 of FIG. 33 uses similar infrastructure as the federated learning framework illustrated in FIG. 32 with the following exceptions. At step 3351 of flow diagram 3300, training data 164 of FIG. 33 is aggregated on application server 140 (controlled by decentralized application 150) where the machine learning models are trained. At step 3352 of flow diagram 3300, after training is complete, the trained models are made available to the application interface, and training data 164 is deleted from compute environment 174 (e.g., the controlled training environment of decentralized application 150) and application server 140.

Although this disclosure describes and illustrates particular steps of flow diagrams 1000 through 3300 of FIGS. 10 through 33, respectively, as occurring in a particular order, this disclosure contemplates any suitable steps for flow diagrams 1000 through 3300 as occurring in any suitable order. Flow diagrams 1000 through 3300 of FIGS. 10 through 33, respectively, may include any suitable steps, which may include all, some, or none of the steps of flow diagrams 1000 through 3300, where appropriate. Although flow diagrams 1000 through 3300 describe and illustrate particular components, devices, or systems carrying out particular actions, this disclosure contemplates any suitable combination of any suitable components, devices, or systems carrying out any suitable actions.

FIG. 34 illustrates a computer system that may be used by the systems and methods described herein, in accordance with certain embodiments. For example, one or more components of system 100 of FIG. 1 may include one or more interface(s) 310, processing circuitry 320, memory(ies) 330, and/or other suitable element(s). Interface 310 receives input, sends output, processes the input and/or output, and/or performs other suitable operation. Interface 310 may comprise hardware and/or software.

Processing circuitry 320 performs or manages the operations of the component. Processing circuitry 320 may include hardware and/or software. Examples of a processing circuitry include one or more computers, one or more microprocessors, one or more applications, etc. In certain embodiments, processing circuitry 320 executes logic (e.g., instructions) to perform actions (e.g., operations), such as generating output from input. The logic executed by processing circuitry 320 may be encoded in one or more tangible, non-transitory computer readable media (such as memory 330). For example, the logic may comprise a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

Memory 330 (or memory unit) stores information. Memory 330 may include one or more non-transitory, tangible, computer-readable, and/or computer-executable storage media. Examples of memory 330 include computer memory (for example, RAM or ROM), mass storage media (for example, a hard disk), removable storage media (for example, a Compact Disk (CD) or a Digital Video Disk (DVD)), database and/or network storage (for example, a server), and/or other computer-readable medium.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein. Embodiments disclosed herein include a method, an apparatus, a storage medium, a system and a computer program product, wherein any feature mentioned in one category, e.g., a method, can be applied in another category, e.g., a system, as well.

What is claimed is:

1. A system comprising one or more processors and one or more computer-readable non-transitory storage media coupled to the one or more processors and including instructions that, when executed by the one or more processors, cause the system to perform operations comprising:
receiving a request for a transaction from a first party, wherein the first party is associated with a first party decentralized identifier (DID);
identifying a second party for the transaction, wherein the second party is associated with a second party DID;
receiving negotiation data from the first party and from the second party;
generating a data model using the first party DID, the second party DID, and the negotiation data; and
generating a hybrid legal document using the data model and a legal prose document.

2. The system of claim 1, wherein the request for the transaction is associated with one of the following:
a direct search for a subject of the transaction, wherein the subject of the transaction is an asset, a person, or a service or service provider;
a search for the subject of the transaction based on one or more search parameters; or
a query requesting submissions of potential subjects of the transaction based on one or more search parameters.

3. The system of claim 1, the operations further comprising:
generating a journal entry using data model parameters of the hybrid legal document;
populating the journal entry with fee values derived from the data model parameters; and
populating the journal entry with financial settlement information.

4. The system of claim 1, the operations further comprising:
determining that the hybrid legal document transfers ownership of an asset from the second party to the first party, wherein the asset is associated with an asset DID;
populating the first party as a new controller of the asset DID; and
removing the second party as a controller of the asset DID.

5. The system of claim 1, the operations further comprising:
identifying a subject DID for a subject of the transaction, wherein the subject of the transaction is associated with an asset, a person, an entity, or a service provider; and
generating the data model using the subject DID.

6. The system of claim 1, the operations further comprising:
identifying a subject of the transaction;
determining, based on the data model, capabilities associated with the subject of the transaction, wherein the capabilities comprise ownership, administration, or authorization capabilities; and
generating a credential graph, wherein the credential graph comprises a claim defining the capabilities associated with the subject of the transaction.

7. The system of claim 1, wherein the hybrid legal document is associated with one of the following:
an asset purchase agreement;
a copyright license;
a lease of real estate property;
a lease of mineral rights;
an employment agreement;
a corporate governance document;
a copyright split sheet;
a will; or
a service provider document.

8. A method, comprising:
receiving a request for a transaction from a first party, wherein the first party is associated with a first party decentralized identifier (DID);
identifying a second party for the transaction, wherein the second party is associated with a second party DID;
receiving negotiation data from the first party and from the second party;
generating a data model using the first party DID, the second party DID, and the negotiation data; and
generating a hybrid legal document using the data model and a legal prose document.

9. The method of claim 8, wherein the request for the transaction is associated with one of the following:
a direct search for a subject of the transaction, wherein the subject of the transaction is an asset, a person, or a service or service provider;
a search for the subject of the transaction based on one or more search parameters; or
a query requesting submissions of potential subjects of the transaction based on one or more search parameters.

10. The method of claim 8, further comprising:
generating a journal entry using data model parameters of the hybrid legal document;
populating the journal entry with fee values derived from the data model parameters; and
populating the journal entry with financial settlement information.

11. The method of claim 8, the operations further comprising:
determining that the hybrid legal document transfers ownership of an asset from the second party to the first party, wherein the asset is associated with an asset DID;
populating the first party as a new controller of the asset DID; and
removing the second party as a controller of the asset DID.

12. The method of claim 8, further comprising:
identifying a subject DID for a subject of the transaction, wherein the subject of the transaction is associated with an asset, a person, an entity, or a service provider; and
generating the data model using the subject DID.

13. The method of claim 8, further comprising:
identifying a subject of the transaction;
determining, based on the data model, capabilities associated with the subject of the transaction, wherein the capabilities comprise ownership, administration, or authorization capabilities; and
generating a credential graph, wherein the credential graph comprises a claim defining the capabilities associated with the subject of the transaction.

14. The method of claim 8, wherein the hybrid legal document is associated with one of the following:
an asset purchase agreement;
a copyright license;
a lease of real estate property;
a lease of mineral rights;
an employment agreement;
a corporate governance document;
a copyright split sheet;
a will; or
a service provider document.

15. One or more computer-readable non-transitory storage media embodying instructions that, when executed by a processor, cause the processor to perform operations comprising:
receiving a request for a transaction from a first party, wherein the first party is associated with a first party decentralized identifier (DID);
identifying a second party for the transaction, wherein the second party is associated with a second party DID;
receiving negotiation data from the first party and from the second party;
generating a data model using the first party DID, the second party DID, and the negotiation data; and
generating a hybrid legal document using the data model and a legal prose document.

16. The one or more computer-readable non-transitory storage media of claim 15, wherein the request for the transaction is associated with one of the following:
a direct search for a subject of the transaction, wherein the subject of the transaction is an asset, a person, or a service or service provider;
a search for the subject of the transaction based on one or more search parameters; or
a query requesting submissions of potential subjects of the transaction based on one or more search parameters.

17. The one or more computer-readable non-transitory storage media of claim 15, the operations further comprising:
generating a journal entry using data model parameters of the hybrid legal document;
populating the journal entry with fee values derived from the data model parameters; and
populating the journal entry with financial settlement information.

18. The one or more computer-readable non-transitory storage media of claim 15, the operations further comprising:
determining that the hybrid legal document transfers ownership of an asset from the second party to the first party, wherein the asset is associated with an asset DID;
populating the first party as a new controller of the asset DID; and
removing the second party as a controller of the asset DID.

19. The one or more computer-readable non-transitory storage media of claim 15, the operations further comprising:
identifying a subject DID for a subject of the transaction, wherein the subject of the transaction is associated with an asset, a person, an entity, or a service provider; and
generating the data model using the subject DID.

20. The one or more computer-readable non-transitory storage media of claim 15, the operations further comprising:
identifying a subject of the transaction;
determining, based on the data model, capabilities associated with the subject of the transaction, wherein the capabilities comprise ownership, administration, or authorization capabilities; and
generating a credential graph, wherein the credential graph comprises a claim defining the capabilities associated with the subject of the transaction.
